(19) United States
(12) Patent Application Publication
(10) Pub. No.: US 2025/0039718 A1
(43) Pub. Date: Jan. 30, 2025

(54) REQUEST, CONFIGURATION, AND REPORTING OF PHASE-BASED MEASUREMENTS FOR CARRIER PHASE POSITIONING

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/718,772

(22) PCT Filed: Dec. 20, 2022
(86) PCT No.: PCT/US2022/082077

§ 371 Date: Jun. 11, 2024

(30) Foreign Application Priority Data
Feb. 2, 2022 (GR) 20220100101

(51) Int. Cl. H04W 24/10; H04L 5/00

(52) U.S. Cl. CPC H04W 24/10; H04L 5/0094

(57) ABSTRACT

Disclosed are systems, apparatuses, processes, and computer-readable media for wireless communication at a user equipment (UE). A process can include receiving, at the UE from a network entity, a phase measurement request from a network entity. The phase measurement request includes properties of one or more pairs of subcarrier sets of at least one reference signal received by the UE. A subcarrier set includes at least one subcarrier. The process can further include transmitting a phase measurement report to the network entity. The phase measurement report includes information associated with a phase measurement performed using at least one subcarrier set pair of the at least one reference signal based on the properties included in the phase measurement request.

### CROSS-REFERENCE TO RELATED APPLICATIONS

This application for Patent is a 371 of international Patent Application PCT/US2022/082077, filed Dec. 20, 2022, which claims priority to Greek patent application No. 20220100101, filed Feb. 2, 2022, all of which are hereby incorporated by reference in their entirety and for all purposes.

### FIELD

The present disclosure generally relates to carrier phase positioning. For example, aspects of the present disclosure relate to systems and techniques for using subcarriers in a wireless communication system for determining a position of a mobile device.

### BACKGROUND

Wireless communication systems have developed through various generations, including a first-generation analog wireless phone service (1G), a second-generation (2G) digital wireless phone service (including interim 2.5G networks), a third-generation (3G) high speed data, Internet-capable wireless service, and a fourth-generation (4G) service (e.g., Long-Term Evolution (LTE), WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users with, for example, a gigabit connection speeds to tens of users in a common location, such as on an office floor. Several hundreds of thousands of simultaneous connections should be supported in order to support large sensor deployments. Consequently, the spectral efficiency of 5G mobile communications should be significantly enhanced compared to the current 4G/LTE standard. Furthermore, signaling efficiencies should be enhanced and latency should be substantially reduced compared to current standards.

### SUMMARY

Systems and techniques are described herein that provide reference signals for enhanced carrier phase measurements for carrier phase positioning with wireless communication systems. In one illustrative example, a process for wireless communications at a user equipment (UE) is provided. The process includes: receiving, at the UE from a network entity, a phase measurement request from a network entity, the phase measurement request including properties of one or more pairs of subcarrier sets of at least one reference signal received by the UE, wherein a subcarrier set includes at least one subcarrier; transmitting a phase measurement report to the network entity, the phase measurement report including information associated with a phase measurement performed using at least one subcarrier set pair of the at least one reference signal based on the properties included in the phase measurement request.

In another example, an apparatus for wireless communications is provided that includes a memory (e.g., configured to store data, such as virtual content data, one or more images, etc.) and one or more processors (e.g., implemented in circuitry) coupled to the memory. The one or more processors are configured to and can: receive, from a network entity, a phase measurement request from a network entity, the phase measurement request including properties of one or more pairs of subcarrier sets of at least one reference signal received by the apparatus, wherein a subcarrier set includes at least one subcarrier; and transmit a phase measurement report to the network entity, the phase measurement report including information associated with a phase measurement performed use at least one subcarrier set pair of the at least one reference signal based on the properties included in the phase measurement request.

In another example, a non-transitory computer-readable medium of a user equipment (UE) is provided that has stored thereon instructions that, when executed by one or more processors, cause the one or more processors to: receive, at the UE from a network entity, a phase measurement request from a network entity, the phase measurement request including properties of one or more pairs of subcarrier sets of at least one reference signal received by the UE, wherein a subcarrier set includes at least one subcarrier; and transmit a phase measurement report to the network entity, the phase measurement report including information associated with a phase measurement performed use at least one subcarrier set pair of the at least one reference signal based on the properties included in the phase measurement request.

In another example, an apparatus for wireless communications is provided. The apparatus includes: means for receiving, from a network entity, a phase measurement request from a network entity, the phase measurement request including properties of one or more pairs of subcarrier sets of at least one reference signal received by the apparatus, wherein a subcarrier set includes at least one subcarrier; and means for transmitting a phase measurement report to the network entity, the phase measurement report including information associated with a phase measurement performed using at least one subcarrier set pair of the at least one reference signal based on the properties included in the phase measurement request.

According to at least one example, a method is provided for wireless communications. The method includes: transmitting, to a user equipment (UE), a phase measurement request including properties of one or more pairs of subcarrier sets of at least one reference signal received by the UE; and receiving, from the UE, a phase measurement report, the phase measurement report including information associated with a phase measurement performed use at least one subcarrier set pair of the at least one reference signal based on the properties included in the phase measurement request.

In another example, an apparatus for wireless communications is provided that includes a memory (e.g., configured to store data, such as virtual content data, one or more images, etc.) and one or more processors (e.g., implemented in circuitry) coupled to the memory. The one or more processors are configured to and can: transmit, to a user equipment (UE), a phase measurement request including properties of one or more pairs of subcarrier sets of at least one reference signal received by the UE; and receive, from the UE, a phase measurement report, the phase measurement report including information associated with a phase measurement performed use at least one subcarrier set pair of the at least one reference signal based on the properties included in the phase measurement request.

In another example, a non-transitory computer-readable medium of a network entity is provided that has stored thereon instructions that, when executed by one or more processors, cause the one or more processors to: transmit, to a user equipment (UE), a phase measurement request including properties of one or more pairs of subcarrier sets of at least one reference signal received by the UE; and receive, from the UE, a phase measurement report, the phase measurement report including information associated with a phase measurement performed use at least one subcarrier set pair of the at least one reference signal based on the properties included in the phase measurement request.

In another example, an apparatus for wireless communications is provided. The apparatus includes: means for transmitting, to a user equipment (UE), a phase measurement request including properties of one or more pairs of subcarrier sets of at least one reference signal received by the UE; and means for receiving, from the UE, a phase measurement report, the phase measurement report including information associated with a phase measurement performed use at least one subcarrier set pair of the at least one reference signal based on the properties included in the phase measurement request.

In some aspects, the apparatus is, is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example wireless communications system, in accordance with some aspects of the present disclosure.

FIGS. 2A and 2B are diagrams illustrating example wireless network structures, in accordance with some aspects of the present disclosure.

FIG. 3 is a diagram of a user equipment (UE) in a wireless communication system that determines a location based on distances from terrestrial transmitting devices, according to some aspects of the present disclosure.

FIG. 4 in as illustration of a carrier phase measurement to determine a distance between a transmitting device and a receiving device based on a phase measurement combination, according to some aspects of the present disclosure.

FIG. 5 is a graph that illustrates the equivalent distances of subcarrier set pairs based on subcarrier spacing of an orthogonal frequency division multiplexing (OFDM) system, according to some aspects of the present disclosure.

FIG. 6 is a sequence diagram of a process for configuring a UE to measure subcarrier set pairs transmitted from a transmission-reception point (TRP) and location management function (LMF) for determining a distance from the UE to the TRP, according to some aspects of the present disclosure.

FIG. 7A is an illustration of wireless communication system and different subcarrier set pair configurations for measuring phase and determining a location from a transmitting device, according to some aspects of the present disclosure.

FIG. 7B is an illustration of wireless communication system and combining phase measurements of different subcarrier set pair configurations to improve determining a location from a transmitting device, according to some aspects of the present disclosure.

FIG. 8 is a flow chart illustrating an example of a process 800 for wireless communications, according to some aspects of the present disclosure.

FIG. 9 is a flow chart illustrating an example of a process 900 for wireless communications, according to some aspects of the present disclosure.

FIG. 10 illustrates an example block diagram of a computing system of a UE, in accordance with some aspects of the present disclosure.

FIG. 11 illustrates an example computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The ensuing description provides example aspects only, and is not intended to limit the scope, applicability, or configuration of the disclosure. Rather, the ensuing description of the exemplary aspects will provide those skilled in the art with an enabling description for implementing an aspect of the disclosure. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As noted above, 5G mobile standard calls for higher data transfer speeds, greater numbers of connections, and better coverage, among other improvements. 5G is expected to support several hundreds of thousands of simultaneous connections. Consequently, there is room to improve the spectral efficiency of 5G mobile communications by enhancing signaling efficiencies and reducing latency. One aspect where such signaling efficiency and reduction in latency can be achieved is the communication of various uplink and downlink reference signals between user equipment and their respective serving base stations.

Reference signals are predefined signals occupying specific resource elements within a time-frequency grid of a resource block and may be exchanged on one or both of downlink and uplink physical communication channels. Each reference signal has been defined by the 3^{rd} Generation Partnership Project (3GPP) for a specific purpose, such as for channel estimation, phase-noise compensation, acquiring downlink/uplink channel state information, time and frequency tracking, among others.

Example reference signals include, but are not limited to, Positioning Reference Signal (PRS), Sounding Reference Signal (SRS), Channel State Information-Reference Signal (CSI-RS), De-Modulation Reference Signal (DMRS), among others. Some reference signals (e.g., PRS, CSI-RS, etc.) are downlink specific signals, while others such as DMRS are sent both on downlink and uplink communication channels. There are also uplink specific reference signals defined by the 3GPP.

Reference signals may be used to determine location measurements using a carrier phase positioning based technique. For example, carrier phase positioning can include measuring the phase a received carrier or subcarrier signal (e.g., a subcarrier of a reference signal, such as a PRS), and using the phase to determine a distance from a transmitter of the signal to a receiver of the signal. In some cases, a phase measurement combination or “wide-laning” can be performed by subtracting the received phases of a pair of subcarrier signals (where each pair of subcarriers can be referred to as a “lane”) and mapping the phase difference to the distance between the transmitting device and the receiving device.

Systems, apparatuses, processes (also referred to as methods), and computer-readable media (collectively referred to herein as systems and techniques) are described herein for providing improved carrier phase positioning. In some implementations, determining distances between a transmitting device (e.g., a gNB or other network entity/device or portion thereof) and a receiving device (e.g., a UE) based on phase measurements is an iterative process and multiple phase measurements of different subcarriers may be desired, for example, due to a coarse accuracy of an initial measurement. The systems and techniques described herein provide for specific lane requests, configuration, and reporting of phase measurements for carrier phase positioning.

According to the systems and techniques described herein, a network entity (e.g., a location server such as a location management function (LMF), a base station, or portion thereof such as in a distributed architecture) can send a measurement report request to a receiving device that identifies various measurements and measurement parameters. The receiving device can select the subcarriers of a reference signal (e.g., a PRS) transmitted from a transmitting device based on the measurement report (with the measurements and parameters) provided by the network entity and in some cases based on a current environment. For example, if the receiving device is a UE and experiencing significant multipath fading in a particular bandwidth, the UE may avoid measurement in that bandwidth. This approach provides the flexibility for the network entity to request pertinent information for a positioning calculation and allows the receiving device to identify and perform the correct or desired measurements.

The systems and techniques described herein can be applied to communications between a network entity (e.g., a base station, location server, etc.) and a user device (e.g., a UE) or to communications between user devices (e.g., between UEs, vehicles, etc.) using sidelink communications (e.g., a cellular based PC5 sidelink interface, 802.11p defined Dedicated Short Range Communication (DSRC) interface, or other direct interface).

The systems and techniques may provide improved user device (e.g., UE or UE device) location estimates or positioning that is achieved by measuring a phase of subcarriers. For example, the systems and techniques can include the use the phase measurements to identify a distance from a transmitting device (e.g., a next generation NodeB (gNB)) and a receiving device (e.g., a UE). In some cases, the phase measurement can be combined with other positioning techniques to improve location estimates. As used herein, a location estimate may be referred to by other names, such as a position estimate, location, location measurement, position, position fix, fix, or the like. A location estimate may be geodetic and may include coordinates (e.g., latitude, longitude, and possibly altitude) or may be civic and include a street address, postal address, or some other description of a location. A location estimate may further be defined relative to some other known location or defined in absolute terms (e.g., using latitude, longitude, and/or altitude). A location estimate may include an expected error or uncertainty (e.g., by including an area or volume within which the location is expected to be included with some specified or default level of confidence).

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmission-reception point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

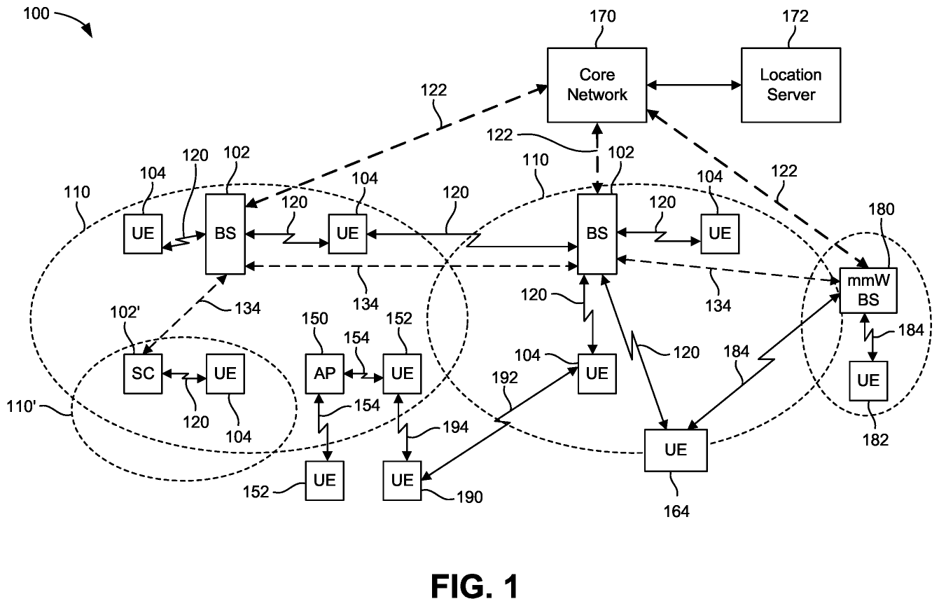

According to various aspects, FIG. 1 illustrates an exemplary wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a CU, a DU, an RU, a Near-RT RIC, or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

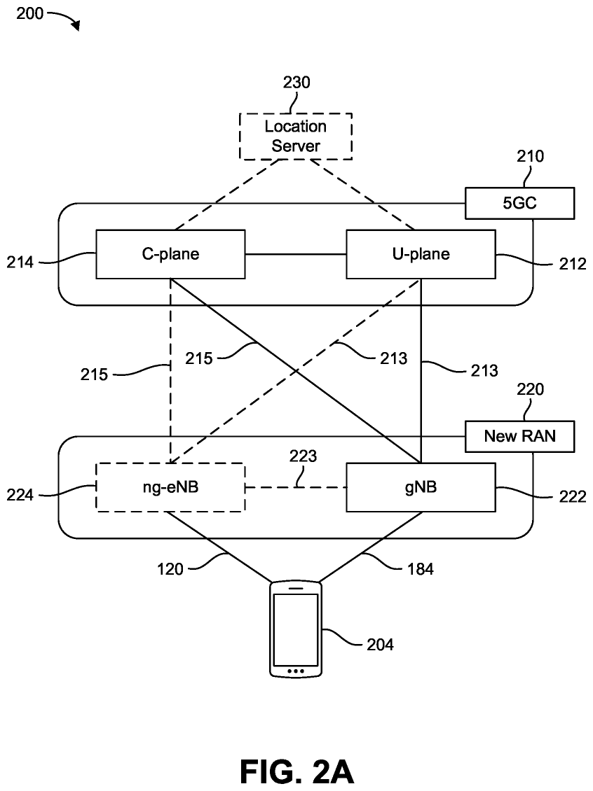

According to various aspects, FIG. 2A illustrates an example wireless network structure 200. For example, a 5GC 210 (also referred to as a Next Generation Core (NGC)) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the control plane functions 214 and user plane functions 212. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1).

Another optional aspect may include location server 230, which may be in communication with the 5GC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated with a component of the core network, or alternatively may be external to the core network. In some examples, the location server 230 can be operated by a carrier or provider of the 5GC 210, a third party, an original equipment manufacturer (OEM), or other party. In some cases, multiple location servers can be provided, such as a location server for the carrier, a location server for an OEM of a particular device, and/or other location servers. In such cases, location assistance data can be received from the location server of the carrier and other assistance data can be received from the location server of the OEM.

According to various aspects, FIG. 2B illustrates another example wireless network structure 250. For example, a 5GC 260 can be viewed functionally as control plane functions, provided by an access and mobility management function (AMF) 264, and user plane functions, provided by a user plane function (UPF) 262, which operate cooperatively to form the core network (i.e., 5GC 260). User plane interface 263 and control plane interface 265 connect the ng-eNB 224 to the 5GC 260 and specifically to UPF 262 and AMF 264, respectively. In an additional configuration, a gNB 222 may also be connected to the 5GC 260 via control plane interface 265 to AMF 264 and user plane interface 263 to UPF 262. Further, ng-eNB 224 may directly communicate with gNB 222 via the backhaul connection 223, with or without gNB direct connectivity to the 5GC 260. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). The network nodes or network entities (e.g., base stations) of the New RAN 220 communicate with the AMF 264 over the N2 interface and with the UPF 262 over the N3 interface.

The functions of the AMF 264 include registration management, connection management, reachability management, mobility management, lawful interception, transport for session management (SM) messages between the UE 204 and a session management function (SMF) 266, transparent proxy services for routing SM messages, access authentication and access authorization, transport for short message service (SMS) messages between the UE 204 and the short message service function (SMSF) (not shown), and/or security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the New RAN 220 and the LMF 270, evolved packet system (EPS) bearer identifier allocation for interworking with the EPS, and UE 204 mobility event notification. In addition, the AMF 264 also supports functionalities for non-3GPP access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink and/or downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as a secure user plane location (SUPL) location platform (SLP) 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

In some aspects, location and positioning functions can be aided by a Location Management Function (LMF) 270 that is configured for communication with the 5GC 260, e.g., to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, New RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

In an aspect, the LMF 270 and/or the SLP 272 may be integrated with a network node or entity (e.g., base station), such as the gNB 222 and/or the ng-eNB 224. When integrated with the gNB 222 and/or the ng-eNB 224, the LMF 270 and/or the SLP 272 may be referred to as a “location management component,” or “LMC.” However, as used herein, references to the LMF 270 and the SLP 272 include both the case in which the LMF 270 and the SLP 272 are components of the core network (e.g., 5GC 260) and the case in which the LMF 270 and the SLP 272 are components of a network node or entity (e.g., base station).

As discussed herein, NR supports a number of cellular network-based positioning technologies, including downlink-based, uplink-based, and downlink-and-uplink-based positioning methods. For example, the LMF 270 can enable positioning based on location measurements computed for various positioning signal (PRS or SRS) resources. As used herein, “PRS resource set” is a set of PRS resources used for the transmission of PRS signals, where each PRS resource has a PRS resource identifier (ID). In addition, the PRS resources in a PRS resource set are associated with the same TRP. A PRS resource set is identified by a PRS resource set ID and is associated with a particular TRP (e.g., identified by a TRP ID). In addition, the PRS resources in a PRS resource set have the same periodicity, a common muting pattern configuration, and the same repetition factor (e.g., PRS-ResourceRepetitionFactor) across slots. The periodicity is the time from the first repetition of the first PRS resource of a first PRS instance to the same first repetition of the same first PRS resource of the next PRS instance. The periodicity may have a length selected from 2^{μ}·{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

In some cases, a PRS resource ID in a PRS resource set is associated with a single beam (and/or beam ID) transmitted from a single TRP (where a TRP may transmit one or more beams). For example, each PRS resource of a PRS resource set may be transmitted on a different beam, and as such, a “PRS resource,” or simply “resource,” can also be referred to as a “beam.” Note that this does not have any implications on whether the TRPs and the beams on which PRS are transmitted are known to the UE.

A “PRS instance” or “PRS occasion” is one instance of a periodically repeated time window (e.g., a group of one or more consecutive slots) where PRS are expected to be transmitted. A PRS occasion may also be referred to as a “PRS positioning occasion,” a “PRS positioning instance,” a “positioning occasion,” “a positioning instance,” a “positioning repetition,” or simply an “occasion,” an “instance,” or a “repetition.”

A “positioning frequency layer” (also referred to simply as a “frequency layer” or “layer”) is a collection of one or more PRS resource sets across one or more TRPs that have the same values for certain parameters. Specifically, the collection of PRS resource sets has the same subcarrier spacing (SCS) and cyclic prefix (CP) type (meaning all numerologies supported for the PDSCH are also supported for PRS), the same Point A, the same value of the downlink PRS bandwidth, the same start PRB (and center frequency), and the same comb size. The Point A parameter takes the value of the parameter ARFCN-ValueNR (where “ARFCN” stands for “absolute radio-frequency channel number”) and is an identifier and/or code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one network node or entity (e.g., a base station, or a macro cell base station and a small cell base station) to transmit data channels, while frequency layers are used by several (usually three or more) a network nodes or entities (e.g., base stations) to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Downlink-based location measurements can include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., PRS, TRS, NRS, CSI-RS, SSB, etc.) received from pairs of network nodes or entities (e.g., base stations), referred to as reference signal time difference (RSTD) or time difference of arrival (TDOA) measurements, and reports them to a positioning entity. More specifically, the UE receives the identifiers of a reference network node or entity (e.g., a serving base station) and multiple non-reference network nodes or entities (e.g., base stations) in assistance data. The UE then measures the RSTD between the reference network node or entity (e.g., reference base station) and each of the non-reference network nodes or entities (e.g., non-reference base stations). Based on the known locations of the involved network nodes/entities (e.g., base stations) and the RSTD measurements, the positioning entity (e.g., LMF 270) can estimate the UE's location. For DL-AoD positioning, a network node or entity (e.g., a base station such as gNB 222) measures the angle and other channel properties (e.g., signal strength) of the downlink transmit beam used to communicate with a UE to estimate the location of the UE.

Uplink-based positioning methods include uplink time difference of arrival (UL-TDOA) and uplink angle-of-arrival (UL-AoA). UL-TDOA is similar to DL-TDOA, but is based on uplink reference signals (e.g., SRS) transmitted by the UE. For UL-AoA positioning, a network node or entity (e.g., a base station) measures the angle and other channel properties (e.g., gain level) of the uplink receive beam used to communicate with a UE to estimate the location of the UE.

Downlink-and-uplink-based positioning methods include enhanced cell-ID (E-CID) positioning and multi-round-trip-time (RTT) positioning (also referred to as “multi-cell RTT or multi RTT”). In an RTT procedure, an initiator (a network node or entity, such as a base station, or a UE) transmits an RTT measurement signal (e.g., a PRS or SRS) to a responder (a UE or base station), which transmits an RTT response signal (e.g., an SRS or PRS) back to the initiator. The RTT response signal includes the difference between the ToA of the RTT measurement signal and the transmission time of the RTT response signal, referred to as the reception-to-transmission (Rx-Tx) measurement. The initiator calculates the difference between the transmission time of the RTT measurement signal and the ToA of the RTT response signal, referred to as the “Tx-Rx” measurement. The propagation time (also referred to as the “time of flight”) between the initiator and the responder can be calculated from the Tx-Rx and Rx-Tx measurements. Based on the propagation time and the known speed of light, the distance between the initiator and the responder can be determined. For multi-RTT positioning, a UE performs an RTT procedure with multiple network nodes or entities (e.g., base stations) to enable its location to be determined (e.g., using multilateration) based on the known locations of the a network nodes (e.g., base stations). RTT and multi-RTT methods can be combined with other positioning techniques, such as UL-AoA and DL-AoD, to improve location accuracy.

To assist positioning operations, a location server (e.g., location server 230, LMF 270, or other location server) may provide assistance data to the UE. For example, the assistance data may include identifiers of the network nodes or entities (e.g., base stations or the cells and/or TRPs of the base stations) from which to measure reference signals, the reference signal configuration parameters (e.g., the number of consecutive positioning subframes, periodicity of positioning subframes, muting sequence, frequency hopping sequence, reference signal ID, reference signal bandwidth, etc.), and/or other parameters applicable to the particular positioning method. Alternatively, the assistance data may originate directly from the network nodes or entities (e.g., base stations) themselves, such as in periodically broadcasted overhead messages, etc. In some cases, the UE may be able to detect neighbor network nodes itself without the use of assistance data.

For DL-AoD, the UE 204 can provide DL-PRS beam RSRP measurements to the LMF 270, whereas the gNB 222 can provide the beam azimuth and elevation angle information. When using an UL angle of arrival (AoA) positioning method, the position of UE 204 is estimated based on UL SRS AoA measurements taken at different TRPs (not illustrated). For example, TRPs can report AoA measurements directly to LMF 270. Using angle information (e.g., angle of departure (AoD) or AoA) together TRP co-coordinate information and beam configuration details, the LMF 270 can estimate a location of UE 204.

For multi-RTT location measurements, the LMF 270 can initiate a procedure whereby multiple TRPs (not illustrated) and a UE perform the gNB Rx-Tx and UE Rx-Tx measurements, respectively. For example, the gNB 222 and UE 204 can transmit a downlink positioning reference signal (DL-PRS) and uplink sounding reference signal (UL-SRS), respectively, whereby the gNB 222 configures UL-SRS to the UE 204 e.g., using the RRC protocol. In turn, the LMF 270 can provide the DL-PRS configuration to the UE 204. Resulting location measurements are reported to the LMF 270 by the UE 204 and/or gNB 222 to perform location estimation for the UE 204.

The 3rd Generation Partnership (3GPP) (e.g., Technical Specification (TS) TS22.261 and others) requires location measurements of devices (e.g., UEs) with sub-meter level performance. Conventional approaches to determining location measurements using terrestrial systems determine a distance using a “code-phase” or an RSTD measurement technique based on a ToA of the signal. In one example of an RSTD measurement, a UE receives signals from several neighboring eNBs and the ToA from each eNB are subtracted from the ToA of a reference eNB to yield an observed time difference of arrival (ODToA) of each neighboring eNBs. Each ODToA determines a hyperbola based on a known function, and a point at which the hyperbolas intersect corresponds to the location of the UE. At least three different timing measurements from geographically dispersed eNBs with good geometry are needed to solve for two coordinates (e.g., latitude and longitude) of the UE. RSTD measurements cannot satisfy the requirement of location measurement with sub-meter level performance due to timing errors and location errors that propagate into each ODToA measurement and reduce the accuracy of the location measurement.

A terrestrial-based system may implement an angle of departure (AoD) method or a Zenith angle of departure (ZoD) method to provide better accuracy and resource utilization within a 3GPP system. There are contributions proposing the use of phase measurement for improving 5G/NR location measurements, however, the feasibility and performance of such proposals have not been sufficiently studied in 3GPP.

In some cases, phase measurement-based location measurements can be achieved using a non-terrestrial system, such as a Global Navigation Satellite System (GNSS), that employs carrier phase positioning techniques to provide centimeter-level accuracy. Carrier phase positioning can be performed by determining timing and/or distance measurements using a wavelength of a subcarrier signal. In contrast to RSTD measurement techniques, carrier phase positioning estimate a phase of a subcarrier signal in the frequency domain.

One example of GNSS measurement techniques that provide sub-meter level performance use real-time kinematic positioning (RTK) to improve the accuracy of current satellite navigation (e.g., GNSS based) systems by configuring a network entity (e.g., a base station such as an eNB, a gNB, etc.) to measure the subcarrier signal and the network entity retransmits the measured phase of the carrier signal to a UE. The UE also measures the phase of the carrier signal from the satellite and compares the phase measurement at the UE and the phase measurement at the network entity to determine the distance of the mobile device from the network entity. While RTK positioning provides better accuracy over conventional GNSS measurement approaches, the accuracy is limited based on the accuracy of the network entity (e.g., the base station), line-of-sight to the satellite, and environmental conditions that can affect the measurements from the satellite system. For example, buildings can create reflections that increase phase error measured by the mobile device and cloudy conditions. RTK positioning is also limited to outdoor environments due to the receiver device requiring a line-of-sight to the satellites.

Bluetooth can also use carrier phase measurement for providing centimeter-level high accuracy positioning services but is limited to indoor environments due to the limited range of Bluetooth communication. Carrier phase measurement with Bluetooth may be inaccurate because the reference devices that transmit the carrier signals may not be fixed and inaccuracies in the location of the reference devices propagate into the carrier phase measurement.

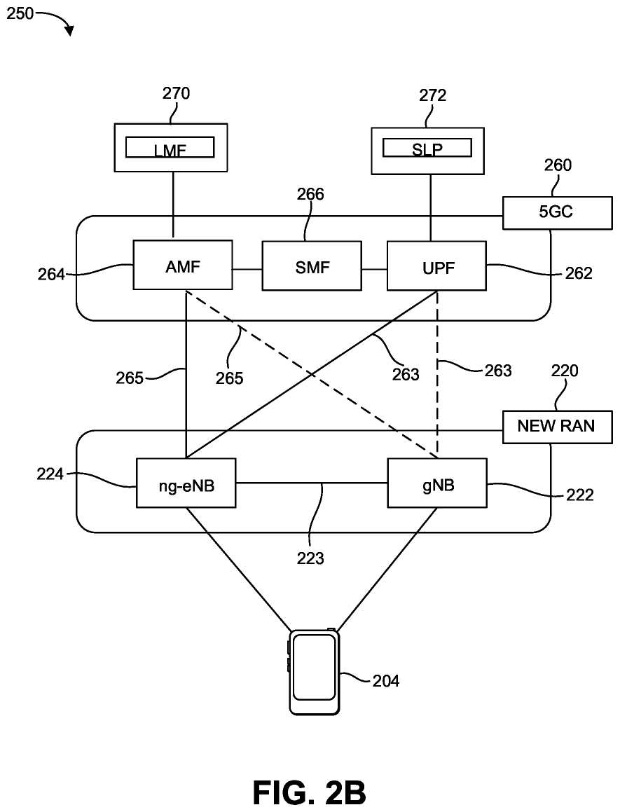

FIG. 3 is a diagram of a UE 305 in a wireless communication system 300 that determines a location based on distances from terrestrial transmitting devices, according to some aspects of the present disclosure. Although FIG. 3 illustrates determining a location of the UE 305 in a wireless networking system relative to network entities 310, 315, and 320, this non-limiting illustration is for explanation purposes and the descriptions herein can be applied to other systems. In another illustrative example, the UE 305 may be a vehicle that employs vehicle-to-everything (V2X) communications with other vehicles or UEs to determine locations relative to other vehicles or objects to perform various driving functions such as lane assist, blind-spot detection, autonomous driving functions, and the like.

As shown in FIG. 3, the wireless communication system 300 includes the UE 305 positioned relative to a network entity 310, a network entity 315, and a network entity 320. In some cases, one or more of the network entities 310, 315, and 320 can be implemented in an aggregated or monolithic base station architecture or in a disaggregated base station architecture (e.g., including one or more of a CU, a DU, a RU, a Near-RT RIC, or a Non-RT RIC). Each of the network entities 310, 315, and 320 transmits a carrier signal that is received by the UE 305. In particular, the network entity 310 transmits the carrier signal 322, the network entity 315 transmits the carrier signal 324, and the network entity 320 transmits the carrier signal 326. In some aspects, the UE 305 can be configured to measure a distance L1 to network entity 310, a distance L2 to network entity 315, and a distance L3 to network entity 320. In one illustrative example, the UE 305 can determine its location based on the distances L1, L2, and L3 and the locations of each of the network entities 310, 315, and 320. In other examples, the UE can measure a parameter such as a carrier phase and transmit the measured parameter to another device, such as a location server (e.g., an LMF), that determines the location of the UE.

In some aspects, the wireless communication system 300 is a system configured to transmit using subcarriers across various frequencies. For instance, the wireless communication system 300 may be an orthogonal frequency division multiplexing (OFDM) system configured to transmit in a licensed frequency band or an unlicensed frequency band using subcarriers that are spaced across the frequency band.

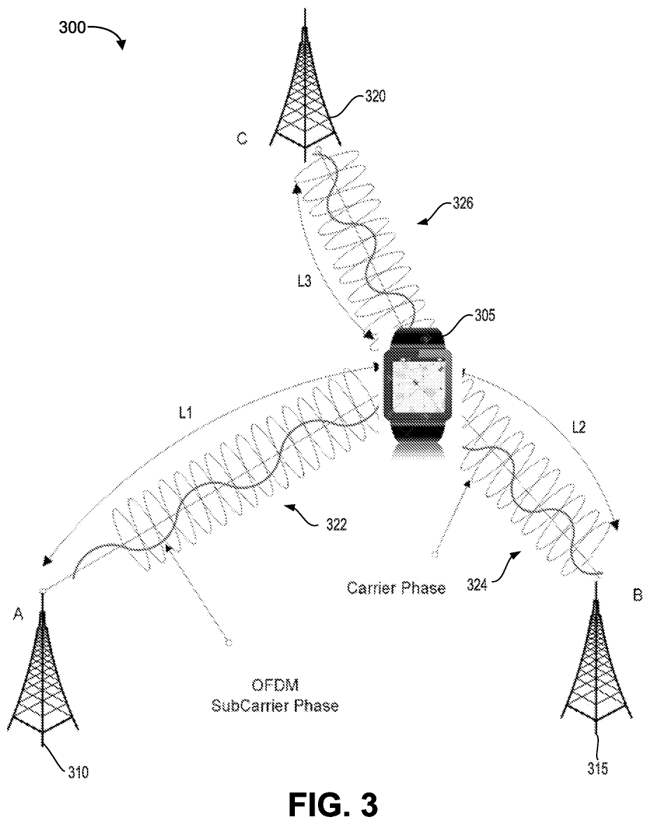

FIG. 4 is an illustration of a transmitting device 405 communicating with a receiving device 410 via signal 420 and a signal 425. The signals 420 and 425 may be subcarrier signals. The transmitting device or the receiving device 410 may be configured to determine a carrier phase measurement that can be used to determine a distance between the transmitting device 405 and the receiving device 410 based on a phase measurement combination. In some aspects, the transmitting device 405 or the receiving device 410 can determine the carrier phase measurement and/or the distance. For instance, the receiving device 410 may determine the carrier phase measurement and may transmit the carrier phase measurement to the transmitting device 405. In another example, the receiving device 410 may determine the carrier phase measurement and may transmit the carrier phase measurement to another network entity, such as a location server (e.g., an LMF). The location server may receive the carrier phase measurement and determine the distance between the transmitting device 405 and the receiving device 410 using the carrier phase measurement. In some examples, the location server may receive distances between one or more other receiving devices and the transmitting device 405. The location server can use the distance determined for the receiving device 410 and the distances between one or more other receiving devices and the transmitting device 405 to determine a location of the receiving device 410 and/or the other receiving devices (e.g., by performing triangulation using the locations).

The signal 420 and the signal 425 are sinusoidal signals. The signal 420 has a wavelength denoted as λ₁ in FIG. 4 and the signal 425 has a wavelength denoted as λ₂. There are an integer number of wavelength cycles for each of the signals (e.g., subcarrier signals), including an integer number Nλ₁ for the signal 420 and an integer number Nλ₂ for the signal 425, as shown in FIG. 4. The receiving device 410 can measure the phase 430 of the signal 420 when the signal 420 is received and can measure the phase 435 of the signal 425 when the signal 425 is received. As shown, there is a fractional wavelength (shown as fractional wavelength λᵢ₁ for the signal 420 and λᵢ₂ for the signal 425) between the beginning of the last period or wavelength and when the signal is received by the receiving device 410. The receiving device 410 can perform carrier phase measurements by first determining the phase at which a signal is received (e.g., the phase 430 of the signal 420) and how many integer number (e.g., Nλ₁ or Nλ₂) of wavelengths have passed. For instance, the distance ρ between the transmitting device 405 and the receiving device 410 can be determined based on the integer number (e.g., Nλ₁ or Nλ₂) of wavelength cycles of a signal (e.g., the signal 420 and/or the signal 425) and the fractional wavelength (e.g., λᵢ₁ or λᵢ₂). In one illustrative example, if the wavelength λ1 is 10 centimeters (cm) and the integer number Nλ₁ of wavelength cycles is 1000, then the distance ρ between the transmitting device 405 and a receiving device 410 can be determined as 10 meters (m) (based on 0.01 m×1000) plus a distance associated with the fractional wavelength λᵢ₁.

As noted above, the general concept of carrier phase measurements (e.g., for carrier/subcarrier-based positioning) is that any distance ρ between a transmitting device 405 (e.g., an eNB, a gNB, etc.) and a receiving device 410 (e.g., a UE) can be represented in terms of N full wavelengths λ and the residual fractional wavelength λᵢ of the subcarrier signal. In mathematical terms, the principle of estimating distance (ρ, also referred to as d) using a carrier phase can be given as follows:

$$ρ = N λ + \frac{ϕ}{2 π} λ \qquad ( Equation 1 )$$

where Nλ is the integer number of wavelength cycles and

$$\frac{ϕ}{2 π} λ$$

is the residual fractional wavelength λᵢ of the subcarrier signal (where the phase ϕ is divided by 2π if the phase is in radians). The wavelength λ of a signal can be determined based c/f, where c is the speed of light (299,792,458 meters per second) and f is the frequency of the signal. For example, a frequency of 3 GHz has a wavelength of 10 centimeters (cm) and a frequency of 500 kilohertz (kHz) has a wavelength of 600 meters. The fractional wavelength (e.g., λᵢ₁ in FIG. 4 or

$$\frac{ϕ}{2 π} λ$$

in Equation (1)) can be determined using a carrier phase measurement.

Measuring the phase ϕ of the received subcarrier signal will only provide the fractional wavelength λᵢ because the carrier phase is periodic. As noted above, the distance ρ between the transmitting device 405 and the receiving device 410 can be determined based on the integer number (e.g., Nλ₁ or Nλ₂) of wavelength cycles of a signal (e.g., the signal 420 and/or the signal 425) and a distance associated with the fractional wavelength (e.g., λᵢ₁ or λᵢ₂). However, typical carrier-phase measurements of a signal can only be used to determine the fractional phase term, as the term N is ambiguous (and cannot be directly measured) because the carrier phase is periodic. For example, a signal may be received by the receiving device 410 with a carrier phase of 0.5π (e.g., 90°), or a length of 2.5 cm for a 3 GHz signal, but the signal may have traveled 2.5 cm, 12.5 cm, or 102.5 cm. The receiving device 410 receives the signal 420 with a fractional wavelength λᵢ₁ and receives the signal 425 with a fractional wavelength λᵢ₂ that is greater than fractional wavelength λᵢ₁ (e.g., based on the signal 425 having a higher frequency than the signal 420, based on being transmitted at different times, etc.). Therefore, an estimation or an inference is required (e.g., via different cycle count techniques) to determine N and thus to determine the distance ρ from the transmitting device 405 to the receiving device 410.

In some aspects, the number of integer cycles N can be inferred and an unknown distance to the receiving device 410 can be determined based on a carrier phase measurement using terrestrial transmitting devices (e.g., a gNB, a beacon, etc.). If the receiving device 410 receives and determines distances to at least two terrestrial transmitting devices that have a known location, the receiving device 410 may be able to determine the location of the receiving device 410 without non-terrestrial sources (e.g., satellites). As noted above, systems and techniques described herein can be used to determine an unknown distance between a transmitting device and a receiving device using carrier phase measurements from terrestrial devices in both indoor and outdoor environments. In some aspects, the systems and techniques disclosed herein can be applied to other non-terrestrial devices in a licensed band or an unlicensed band.

As noted above, the received phase ϕᵢ of the i^{th} carrier or subcarrier signal (e.g., the phase 430 of the signal 420 shown in FIG. 4) can be measured at the receiving device 410. In particular, the carrier phase can be determined based on Equation 2 below.

$${ϕ}_{i} = \frac{2 π ( ρ - {N}_{i} {λ}_{i} )}{{λ}_{i}} + {e}_{{ϕ}_{i}} \qquad ( Equation 2 )$$

In equation 2, Nᵢ is an ambiguous integer of wavelength cycles (as noted above), ρ is the distance between the transmitting device 405 and the receiving device 410, λᵢ is the wavelength of the i^{th} carrier or subcarrier signal, and e_{ϕ}_{ᵢ} is the noise in the phase measurement. In some aspects, the received frequency domain resource elements (REs) of an OFDM-based reference signal (e.g., PRS, SRS, etc.) channel with a simple delay can be modeled by Equation 3 below:

$${R}_{k} = {D}_{k} {e}^{- \frac{j 2 π k Δ f ρ}{c}} + {W}_{k} \qquad ( Equation 3 )$$

In Equation 3, k corresponds to a subcarrier according to the following:

$$k = - \frac{{N}_{RB}}{2} , … , - 1 , 0 , 1 , … , \frac{{N}_{RB}}{2} ,$$

where N_{RB} is the number of resource blocks (RBs). The term k can be considered a subcarrier index that identifies a frequency of the signal. The term Rₖ in Equation 3 above is the frequency domain RE transmitted on carrier k, Dₖ is the time domain representation of the symbol transmitted on carrier k, and Wₖ is the noise at the subcarrier k. Equation 3 can be further simplified into Equation 4 below.

$${R}_{k} = {D}_{k} {e}^{- \frac{j 2 π k ρ}{{λ}_{Δ}}} + {W}_{k} , where {λ}_{Δ} = \frac{c}{Δ f} \qquad ( Equation 4 )$$

In Equation 4, λ_{Δ} is the wavelength difference of two subcarrier frequencies. After a descrambling operation, the frequency domain PRS REs can be represented by Equations 5 and 6 below.

$${R}_{k}^{′} = {‖ {D}_{k} ‖}^{2} {e}^{- \frac{j 2 π k ρ}{{λ}_{Δ}}} + {D}_{k}^{*} {W}_{k} \qquad ( Equation 5 )$$

$${R}_{k}^{′} = {e}^{- \frac{j 2 π k ρ}{{λ}_{Δ}}} + {W}_{k}^{′} \qquad ( Equation 6 )$$

The carrier phase of a k^{th} subcarrier can be determined based on the arctangent of the imaginary part of the frequency domain PRS RE divided by the real part of frequency domain PRS RE as identified in Equation 7 below.

$${ϕ}_{k} = - {tan}^{- 1} ( \frac{Im \{ {R}_{k}^{′} \}}{Re \{ {R}_{k}^{′} \}} ) = \frac{2 π k ρ}{{λ}_{Δ}} - 2 π {N}_{k} \qquad ( Equation 7 )$$

In this case, Nₖ∈ [symbol] is an ambiguous number of full wavelength cycles that cannot be directly measured, and ϕₖ∈(−π, π) is the phase observation for the k^{th} sub-carrier.

In some aspects, by combining the carrier phase measurements ϕ of different subcarriers, the measuring device (e.g., the transmitting device 405, the receiving device 410, or another network entity such as an LMF) may remove the ambiguity of the integer number of cycles N. For example, instead of directly mapping a phase (e.g., the phase 430 of signal 420) to a distance, as described above, a device can subtract the received phases of a pair of subcarrier signals (denoted as ϕₖ−ϕₖ₋ₘ below) or a pair of set of subcarriers. A subcarrier set includes at least one subcarrier. One example of a “set of subcarriers” is a set with a single subcarrier. In such an example, a pair of subcarriers would be two subcarriers (as each set would include a single subcarrier). In some examples, “X subcarriers” (e.g., consecutive subcarriers) can be included in a set of subcarriers. In such examples, the measuring device can derive a single phase measurement for the set of subcarriers including X subcarriers. The measuring device can also derive a single phase measurement (e.g., an effective, average, median, or other representative phase of the set of subcarriers) for a second set of subcarriers including the same number (X) of subcarriers or a different number (e.g., Y) of subcarriers. Using the two phase measurements, the measuring device can determine the difference (e.g., ϕₖ−ϕₖ₋ₘ as described below with respect to equation 8, where the ϕₖ is effective, average, median, or other representative phase of the set of subcarriers) between the two phase measurements. The terms subcarrier pair (or pair of subcarriers) and subcarrier set pair (or pair of set of subcarriers) will be used interchangeably herein.

In one illustrative example, for a pair of subcarriers x1, x2, the measuring device (e.g., UE) can derive two phases ϕ₁, ϕ₂. For a pair of set of subcarriers {x1a,x1b,x1c, . . . x1w}, {x2a,x2b,x2c, . . . x2w}, the measuring device can derive two phases as follows: ϕ₁, ϕ₂ where ϕ₁ is derived based on {x1a,x1b,x1c, . . . x1w} and ϕ₂ is derived based on {x2a,x2b,x2c, . . . x2w}. Further details regarding phase differences (e.g., ϕₖ−ϕₖ₋ₘ) are as described below with respect to equation 8.

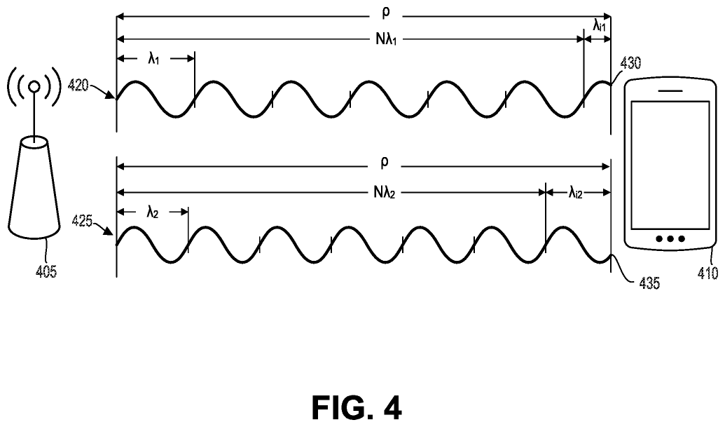

For two subcarriers that are close together in the frequency domain, the wavelengths of the two subcarriers are close together, in which case the number of cycles of the subcarriers between a transmitting device (e.g., transmitting device 405) and a receiving device (e.g., receiving device 410) will be similar. Subtracting the respective phases of the two close-by subcarriers (denoted as λ_{Δ}^{m}ΔNₘ below) will thus result in the number N of wavelength cycles being canceled out or reduced to a negligible value, as shown by the equations below. As a result, as shown in Equation (11) below, the phase difference between the sub-carriers can map directly to the distance d between a transmitting device and a receiving device (e.g., transmitting device 405 and receiving device 410). Such a technique can thus be performed to determine a distance between a transmitting device and a receiving device even in view of the ambiguous number of cycles N. In some aspects, a pair of subcarriers (or pair of set of subcarriers) may be referred to as a “lane,” and the operation of determining the distance from the transmitting device and the receiving device based on the difference in the phase measurements of a subcarrier pair (or subcarrier set pair) can be referred to as a phase measurement combination or “wide-laning”. Examples of various subcarrier pairs/subcarrier set pair and corresponding wavelengths are illustrated in FIG. 5. Mathematical details of phase measurement combining (or wide-laning) using different subcarrier pairs are further detailed below with reference to descriptions related to Equations 8 to 10.

In some aspects, an OFDM system transmits across a licensed or unlicensed frequency band (e.g., 5 GHz) that assigns each subcarrier a distinct center frequency with a fixed bandwidth, and the subcarriers are separated by a subcarrier spacing such as 30 kHz. A subcarrier is associated with a subcarrier index that identifies a distinct center frequency of each distinct subcarrier based on the subcarrier spacing. In some communication systems, subcarriers of a particular frequency band may also be separated by a guard interval to address potential interference from communication devices that are also communicating in that same frequency band. Equation 8 below illustrates how the carrier phase measurements of two different subcarriers, subcarrier k and subcarrier k-m with corresponding carrier phases denoted as ϕₖ and ϕₖ₋ₘ, can be combined based on the carrier phase measurement from Equation 7.

$${ϕ}_{k} - {ϕ}_{k - m} = 2 π d \frac{k}{{λ}_{Δ}} - 2 π {N}_{k} - 2 π d \frac{k - m}{{λ}_{Δ}} + 2 π {N}_{k - m} \qquad ( Equation 8 )$$

In some aspects, the number of cycles Nₖ and Nₖ₋ₘ may be equal or may be similar. The phase of the subcarrier set pair, being separated by subcarrier difference m, can be compared to yield a phase measurement difference Δϕm (as illustrated in Equation 9 below), which can be used to determine a distance d from the transmitting device 405 and receiving device 410 (as illustrated in Equation 10 below).

$${ϕ}_{k} - {ϕ}_{k - m} = Δ {ϕ}_{m} = \frac{2 π d}{\frac{{λ}_{Δ}}{m}} + 2 π ( {N}_{k - m} - {N}_{k} ) = \frac{2 π d}{{λ}_{Δ}^{m}} + 2 π Δ {N}_{m} \qquad ( Equation 9 )$$

Based on equation 9, the phase measurement difference Δϕm determined using Equation 9 can be used in Equation 10 below to determine a distance d from a transmitting device (e.g., transmitting device 405) to the receiving device (e.g., receiving device 410).

$$d = {λ}_{Δ}^{m} \frac{Δ {ϕ}_{m}}{2 π} + {λ}_{Δ}^{m} Δ {N}_{m} \qquad ( Equation 10 )$$

where λ_{Δ}^{m} is the equivalent wavelength of a subcarrier combination with sub-carrier separation of mΔf, m is the subcarrier difference, and Δf is the spacing between subcarriers.

In one illustrative example, a first subcarrier of the subcarrier set pair has an index value of 1, corresponding to a subcarrier frequency of 5000.03 MHz, and a second subcarrier of the subcarrier set pair has an index value of 2, corresponding to subcarrier frequency of 5000.06 MHz (e.g., a SCS of 30 kHz), with the subcarrier difference of 1. In this example, the subcarriers are spaced at 30 kHz intervals, and the equivalent wavelength λ_{Δ}¹ of the subcarrier set pair is based on

$$\frac{c}{Δ f} = \frac{299 , 792 , 458 m / s}{( 2 - 1 ) * 30 kHz} ,$$

or approximately 10 kilometers (km). The wavelengths of the subcarriers in this example are nearly equal based on the 30 kHz frequency difference. Because of the similar wavelength of the subcarrier frequencies, the subcarriers will need to travel a large distance before the number of cycles of the higher frequency subcarrier will increase and be different than the number of cycles of the lower frequency subcarrier.

In some aspects, a larger difference in frequencies between subcarrier set pairs will increase the difference in wavelengths (ΔNₘ) between the subcarriers in each subcarrier set pair. However, the value of ΔNₘ does not need to be zero, since the value of ΔNₘ for each subcarrier set pair can be known.

In some cases, there may be a maximum number of resource blocks (RBs) that can be assigned to a particular signal (e.g., a positioning reference signal (PRS), sounding reference signal (SRS), demodulation reference signal (DMRS), Channel State Information Reference Signal (CSI-RS), etc.). For example, there may be a maximum of 272 RBs that are assignable to a PRS. In such an example, presuming a comb 1, symbol 1 RB structure with 12 assignable tones, there are 272×12=3264 different subcarrier assignments. Presuming that the largest subcarrier distance is used (e.g., the first subcarrier having an index of 1 and the last subcarrier having an index value of 3264), the two subcarriers of the subcarrier set pair are separated by 3263 subcarriers, and the equivalent wavelength is

$$\frac{299 , 792 , 458 m / s}{3263 \times 30 kHz} = 3 m .$$

If the shortest subcarrier distance is used (e.g., the first subcarrier having an index of 1 and the next subcarrier having an index of 2), then the two subcarriers of the subcarrier set pair are separated by 3263 subcarriers, and the equivalent wavelength is

$$\frac{299 , 792 , 458 m / s}{s \times 30 kHz} = 9 , 931 m ( or 10 km ) .$$

In some aspects, there are more subcarrier set pairs with a larger equivalent wavelength than subcarrier set pairs with a shorter equivalent wavelength. For example, there is a single subcarrier set pair combination that yields a subcarrier distance of 3263 (e.g., subcarrier set pair [1, 3264]), and there are at 3263 subcarrier set pairs having a subcarrier spacing of 1 (e.g., [1, 2], [2, 3], [3, 4], . . . , [3263, 3264]). In some aspects, a narrow subcarrier set pair (corresponding to a wide lane) refers to subcarriers that are relatively close together in frequency and have similar wavelengths, and a wide subcarrier set pair (corresponding to a narrow lane) refers to subcarriers that are farther apart in frequency and have less similar wavelengths as compared to the narrow subcarrier set pairs, which is illustrated herein with reference to FIG. 5.

Different subcarrier combinations may be used to identify an unknown location of a device because a narrow subcarrier set pair or a wide subcarrier set pair will not be able to produce accurate initial results for every case. For example, a narrow subcarrier group may be inaccurate because the receiving device may be close to the transmitting device (e.g., 200 m), in which case the phase differences of the narrow subcarrier set pair may be outside of a measurement sensitivity of a phase measurement device on the receiving device and the measured phase will be dominated by noise (e.g., e_{ϕ}_{ᵢ}). In the case that phase of each subcarrier measurement is below the noise floor of the measurement (e.g., e_{ϕ}_{ᵢ}) and the difference in the subcarrier phase is zero, the measured phase yields a distance of zero from the transmitting device to the receiving device. In some aspects, a zero distance indicates that the transmitting device and the receiving device occupy the same physical space, which is not possible. In this case, the narrowest subcarrier group cannot be used to determine the distance between transmitting device 405 and the receiving device 410. The widest subcarrier group also cannot determine the distance between transmitting device 405 and the receiving device 410 because the receiving device 410 is outside of the smallest equivalent wavelength of 3 m and there are an ambiguous number of cycles N.

In some aspects, the wide subcarrier set pair can be used if an initial location is known and the number of cycles can be determined. For example, if a location of a receiving device is known within a 3 meter radius, the widest subcarrier set pair identified (e.g., subcarrier set pair [1, 3264]) above can be used to identify a location in units of centimeters within that 3 meter radius. In some aspects, narrow subcarrier set pairs can be used to identify a coarse location within larger areas but with lower accuracy, and then different subcarrier set pairs can be used to identify a location within a smaller area but with higher accuracy.

FIG. 5 is a graph that illustrates the wavelengths of subcarrier set pairs based on subcarrier spacing of an OFDM system and wavelength differences of the subcarrier set pairs, according to some aspects of the present disclosure. In FIG. 5, the equivalent wavelength of the subcarrier set pairs are illustrated by reference numeral 505 and the wavelength differences are illustrated by reference numeral 510. As described above, narrower subcarrier set pairs have large equivalent wavelengths based on the wavelength of their subcarriers being closer than wider subcarrier set pairs.

In some aspects, to address multipath fading, the time domain signal may need additional processing to remove earlier or later multipath signals. An inverse fast Fourier transform (IFFT) may determine that the PRS tone has some multipath components and the tone is converted back into the time domain and a time domain window function is applied to remove earlier or later received multipath signals. After the window function, the time domain representation of the tone is converted back into the frequency domain. In some aspects, techniques to reduce the effects of multipath fading may be expensive due to conversion into the time domain and then conversion back into the frequency domain.

As noted above, systems and techniques are described herein for improving carrier phase positioning. For example, a network entity (e.g., a location server such as a location management function (LMF), a base station such as a gNB, or portion thereof such as in a distributed architecture) can transmit information to another network entity (e.g., a location server transmitting the information to a base station or a portion thereof) or directly to a receiving device (e.g., a UE) with subcarrier set pair (or lane) parameters or properties that the receiving device can use in performing phase measurements. In some cases, the information can be included in a measurement report request message to be received by the receiving device. The receiving device can select the subcarriers of a reference signal (e.g., a PRS) transmitted from a transmitting device based on the measurement parameters or properties.

In some aspects, the network entity (e.g., the location server, gNB, etc.) can request specific lane properties to be used. For instance, in some cases, the network entity can transmit signaling (e.g., a measurement report request message) to a UE requesting a specific number of subcarrier set pairs (or lanes) to be used for measurement and reporting by the UE. In one example, the request may be included in a LocationRequest message (e.g., defined in 3GPP TS 37.355) for each method, and/or for each positioning frequency layer (PFL) of the assistance data. For instance, the network entity may request X subcarrier set pair measurements from a UE by signaling a downlink message (e.g., a LocationRequest message) to the UE. In some cases, the UE may be free to choose any of the X subcarrier set pairs, such as based on a local quality metric of the UE, which can be dependent on a particular implementation of the UE. In such cases, the UE may report (e.g., via signaling in an uplink message) which lane it used for reporting. In some examples, the UE may include single lane information for all phase measurements across all reference signal (e.g., PRS, sounding reference signal (SRS) resources, demodulation reference signal (DMRS) resources, Channel State Information Reference Signal (CSI-RS) resources, etc.) resources, sets, transmission reception points (TRPs), PFLs, etc.) or may include separate lane information for each phase measurement.

In some examples, subcarrier set pair/lane reporting can be function of frequency distance, such as in terms of subcarrier spacing. In some cases, network entity (e.g., LMF, gNB, etc.) may request multiple subcarrier set pairs to be used for measurements. In such cases, the network entity may order the multiple subcarrier set pairs/lanes, such as in decreasing priority order or increasing priority order. In some examples, a UE may be expected (e.g., as defined in a 3GPP TS, such as 3GPP TS 37.355 or other TS) to perform and report measurements on different subcarrier set pairs (or lanes) depending on the assigned priority order.

In some cases, a network entity (e.g., LMF, gNB, etc.) may request a specific set of one or more subcarrier set pair(s)/lane(s) and/or specific size(s) of each of the subcarrier set pairs for reporting. For instance, in some cases, the network entity can send signaling to a UE requesting the specific set of one or more subcarrier set pair(s)/lane(s) and size(s) of each subcarrier set pair for reporting. For example, the network entity can request the measurement from a narrow subcarrier set pair/lane, a wide subcarrier set pair/lane, and/or a middle level subcarrier set pair/lane. The definition of “narrow”, “wide”, and “middle” in this context may be related to the SCS, bandwidth, frequency, band, etc. used. In some cases, the meaning of “narrow”, “wide”, and “middle” may be configurable. For example, the terms can be configurable in the sense that a network entity can request the measurement from subcarrier set pairs with the following characteristics: 0 to 10 meters, 10 to 100 meters, 100-to-1000-meters, etc. These numbers/thresholds can be configured by the network entity (e.g., LMF, gNB, etc.) to the UE. In another example, the terms can be configurable in the sense that the network entity can request the measurement from subcarrier set pairs/lanes with a subcarrier distance of 1-10, 50 to 500 meter, 1000-3000, etc. These numbers/thresholds can also be configured by the network entity to the UE. In some instances, there will be cases where the UE still has the capability of measuring multiple subcarrier set pairs/lanes inside of each specific subcarrier set pair defined by the network entity. In such cases, the UE may be free to choose any subcarrier set pair based on a local quality metric of the UE (which may be based on an implementation of the UE). The UE may report which subcarrier set pair it used for reporting. In some examples, subcarrier set pair/lane reporting can be function of frequency distance, such as in terms of subcarrier spacing.

In some aspects, a UE can report measurements when specific subcarrier set pair/lane properties have been requested. In some examples, a UE may report phase information derived using associated subcarriers with a given frequency domain distance. The UE may determine which subcarriers to select. There may be multiple options to report carrier phase measurements (e.g., one or more Δϕₘ measurements) for positioning. In one example, the UE may report one or more carrier phase measurements (e.g., the Δϕₘ measurements), such as instantaneous measurements or measurements averaged over one more subcarriers with the same fixed distance. In another example, the UE may report one or more carrier phase measurements (e.g., the Δϕₘ measurements) after resolving integer ambiguity. In another example, the UE may report both one or more carrier phase measurements (e.g., the Δϕₘ measurements) and integer ambiguity N after resolving integer ambiguity.

In some examples, the network entity (e.g., LMF, gNB, etc.) may send signaling requesting the UE to send back the integer N (related to the integer ambiguity noted above) associated with a particular carrier phase measurement (e.g., Δϕₘ measurement).

In some examples, the network entity (e.g., LMF, gNB, etc.) may request a median, mean, standard deviation, or other representative value of a set of carrier phase measurements (e.g., Δϕₘ measurements) derived on a same subcarrier set pair/lane. In some examples, the network entity (e.g., LMF, gNB, etc.) may request a median, mean, standard deviation, or other representative value of a set of carrier phase measurements (e.g., Δϕₘ measurements) derived on a set of subcarrier set pairs/lanes. In some examples, the network entity (e.g., LMF, gNB, etc.) may request a median, mean, standard deviation, or other representative value of a set of carrier phase measurements (e.g., Δϕₘ measurements) derived on a specific segment of a subcarrier set pair/lane, such as a subcarrier set pair defined between 0 to 10 meter, a subcarrier set pair defined between 10-to-100-meter, etc.

In some examples, the network entity (e.g., LMF, gNB, etc.) may request a number of measurements associated with each chosen subcarrier set pair/lane. For instance, the network entity may request X number of measurements that have the highest quality (e.g., as measured by a quality criterion related to the carrier phase measurements) out of a number of carrier phase measurements (e.g., Δϕₘ measurements). In some cases, the UE will report to the network entity according to the request it received by the network entity.

In some examples, the network entity (e.g., LMF, gNB, etc.) may recommend an upper bound of the distance of the subcarriers for the creation of a subcarrier set pair/lane. In some such examples, the UE may be able to select a smaller distance and report it to the network entity. In some cases, the network entity may recommend a lower bound of the distance of the subcarriers for the creation of the subcarrier set pair. In some such cases, the UE may be able to select a larger distance and report it to the UE.

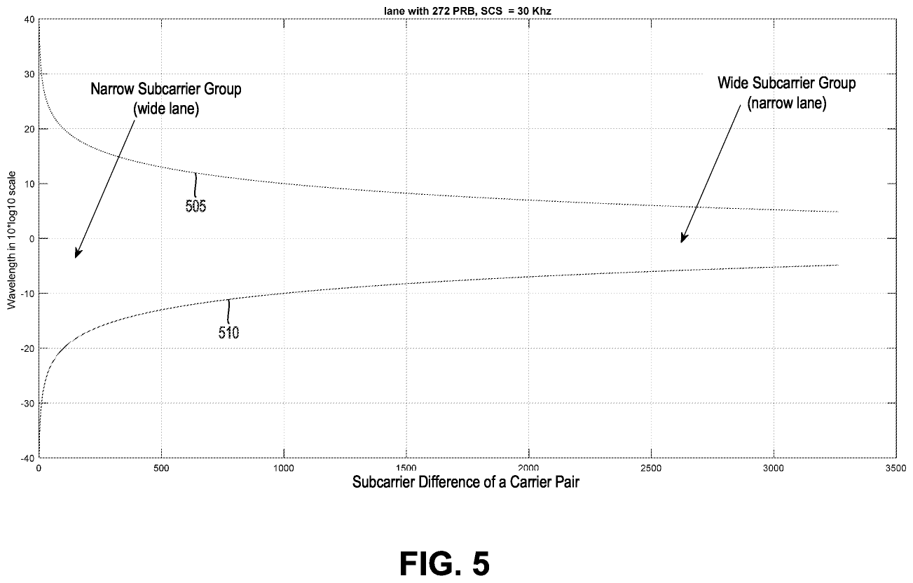

Further details regarding such systems and techniques are described below with respect to FIG. 6-FIG. 8.

FIG. 6 is a sequence diagram of a process for configuring a UE 602 to measure subcarrier set pairs transmitted from a TRP 604 and LMF 606 for determining a distance from the UE 602 and the TRP 604, according to some aspects of the present disclosure. In some aspects, the phase measurements can be combined with existing measurement techniques (e.g., TDoA, RSTD, etc.) to improve the quality of the measurements. The TRP 604 may include of a radio unit (RU) that transmits signals from a fixed location. In some aspects, the TRP 604 may receive baseband from a baseband unit (BBU) pool that implements a centralized RAN (C-RAN) or may receive a baseband from a virtualized RAN (vRAN). The TRP 604 includes devices to convert the received baseband into RF signals and transmit the RF signals (e.g., modulators, power amplifiers, low noise amplifiers, etc.).

Initially, the LMF 606 is configured to receive an indication of UE presence within a transmission area of the TRP 604 at block 610. The indication of the UE presence can be signaled to the LMF 606 in a variety of ways such as by another TRP (not shown) that has a common coverage area with the TRP 604 and is communicating with the UE 602. In another example, the UE 602 can set up a wireless connection with the TRP 604, and the TRP 604 can send a message to the LMF 606 indicating presence of the UE 602. The UE 602 may also send a message to the LMF 606 indicating presence of the UE 602 near or within a coverage area of the TRP 604.

At block 610, the LMF 606 can determine phase measurement parameters for the UE 602 that can be used (e.g., by the UE 602, by the LMF 606, by the base station or portion thereof including the TRP 604, or other device) to perform phase measurements to determine a distance from the UE 602 to the TRP 604. In some aspects, the distance from the UE 602 to the TRP 604 may be used by the UE 602, TRP 604, or LMF 606 to determine a location of the UE 602. For example, a network entity (e.g., the LMF 606) can use the carrier phase measurements to determine the location of the UE 602 with centimeter-level accuracy based on a subcarrier set pair (or lane). In some aspects, the LMF 606 can determine the phase measurement parameters that include different subcarrier set pair configurations for determining an absolute location of the UE 602 without any prior location information, or for determining a relative location with some prior location information. As described above, each subcarrier of a subcarrier set pair can have an equal or similar number of integer cycles between the transmission point (e.g., TRP 604) and a reception point (e.g., UE 602). Detailed descriptions of the phase measurement parameters and the subcarrier set pair configurations will now be described.

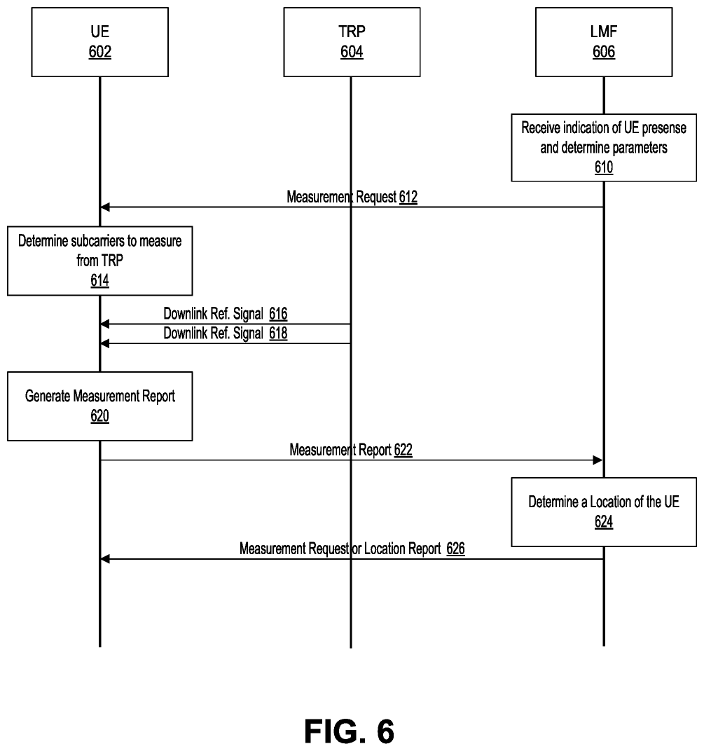

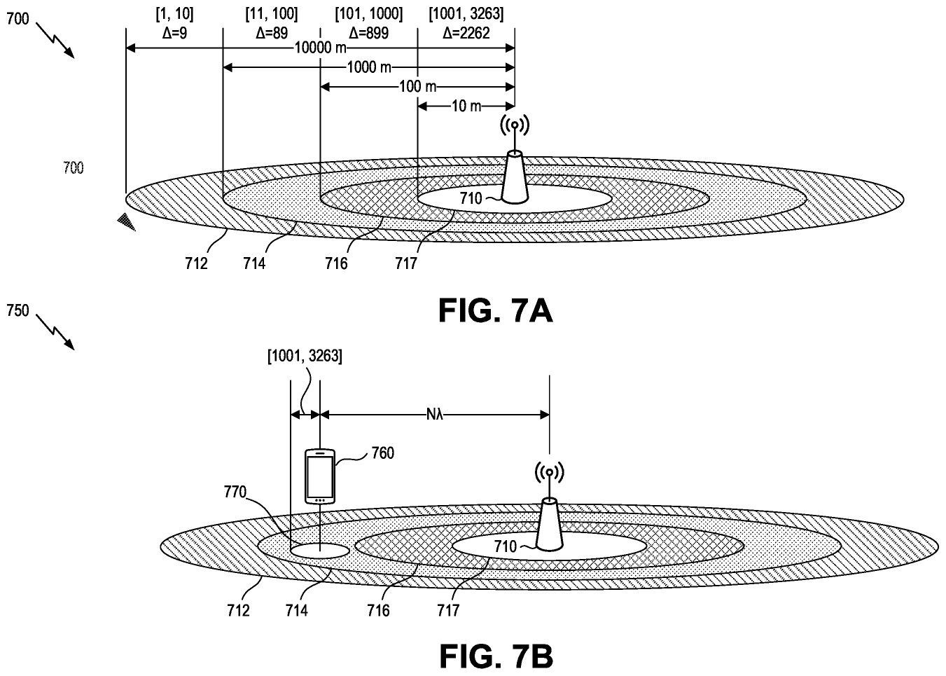

In some aspects, the LMF 606 can determine subcarrier set pair configurations that that separate subcarrier set pairs into groups. Table 1 below illustrates six different subcarrier set pair configurations based on a subcarrier spacing of 30 kHz. In one illustrative, the largest range configuration (Configuration 1) requires a higher frequency subcarrier and a lower frequency subcarrier be separated by at least 1 subcarrier (e.g., subcarrier group [322, 323]) and at most 4 subcarriers (e.g., subcarrier group [322, 326]). An example of subcarrier set pair configurations is further described herein with reference to FIGS. 7A and 7B.

TABLE 1

| Configuration | Subcarrier | Distance |
|---|---|---|
| Identifier | Difference | (m) |
| 1 | 1-5 | 10,000-2,000 |
| 2 | 6-10 | 1,999-1,000 |
| 3 | 11-50 | 999-500 |
| 4 | 51-100 | 499-200 |
| 5 | 101-1000 | 199-100 |
| 6 | 1001-3000 | 99-10 |

In Table 1, the distance corresponds to an equivalent distance, or a maximum range, of the subcarriers in that configuration. For example, a subcarrier difference of 1 has an equivalent distance of 10,000 meters (m), and a subcarrier difference of 5 has an equivalent distance of 2,000 m. The LMF 606 may separate the pairs into distinct groups, or lanes, because there are a larger number of narrow subcarrier set pairs than wider subcarrier set pairs. Based on these different configurations, the UE 602 will be able to iteratively increase the distance between the subcarriers of the subcarrier set pair to increase accuracy of the measurements.

In some aspects, the LMF 606 may configure various aspects of the phase measurements of the UE 602. For example, the LMF 606 may determine a priority of subcarrier set pair configurations. In one illustrative example, the LMF 606 may be unaware of the position of the UE 602 and may therefore prioritize measurements using subcarrier set pairs that are farther apart in frequency. In another illustrative example, the LMF 606 may be aware of the location of the UE 602 and may use subcarriers that are closer together in frequency to more accurately determine the distance to the UE 602. In this case, the LMF 606 may transmit phase measurement parameters to the UE 602 with the measurement request. In the event the measurement request includes an assessment of distance to the UE 602, the UE 602 may be able to compute a number of wavelength cycles associated with a subcarrier frequency. In some aspects, a network entity such as the LMF 606 can use a known number of wavelength cycles of a wider subcarrier set pair to identify a relative location (e.g., based on another position) to improve the accuracy of the prior position. An example of identifying a known number of wavelength cycles is discussed herein with reference to FIG. 7B.

The LMF 606 can configure the phase measurement parameters to include a measurement count (corresponding to a number of subcarrier set pairs or lanes to be used), an indication of which subcarrier set pairs (or lanes) to use, a subcarrier difference (corresponding to a difference between subcarrier set pairs or lane size), variability, measurement types, and/or a configurable flag. The measurement count can identify a number of measurements for different subcarrier set pairs that would qualify within that subcarrier set pair configuration such as subcarrier set pair [3, 23], subcarrier set pair [103, 123], and subcarrier set pair [203, 223] would correspond to pair configuration 3 in Table 1. In some aspects, the measurement type can identify how the UE configures the report by, for example, taking a mean of the different measurements, reporting each measurement (e.g., instantaneous), or performing other statistical functions such as standard deviation, which would indicate the stability of the measurement. In some cases, the LMF 606 can configure multiple measurements such as including a mean and a standard deviation of all measurements associated with that subcarrier set pair configuration.

In some aspects, the LMF 606 may include a specific subcarrier difference based on previous measurements. For example, if the LMF 606 determines that a TRP has a particular range (e.g., the TRP has a small transmission power due to an indoor environment), the LMF 606 can prefer larger subcarrier differences (e.g., narrower lanes). The subcarrier difference can be modified based on a variability value in the phase measurement parameter that may indicate a range associated with the subcarrier set pair configuration. For example, a subcarrier distance of 20 and a variability of 10 would indicate a difference of 20 between subcarriers within a range of ±10 subcarriers. The LMF 606 may also allow the UE 602 to override a configuration of measurement parameter in some circumstances.

The various aspects of the phase measurement parameters can be applied on a subcarrier set pair configuration basis (e.g., for each different subcarrier set pair configuration) or a measurement report basis (e.g., one or more parameters that are applied to all subcarrier set pair configurations). For example, Table 2 below illustrates an example of phase measurement parameters with each subcarrier set pair configuration having different parameters, which is illustrated in JavaScript object notation (JSON) for illustrative purposes only.

TABLE 2

```
{
  “currentDistanceEstimate”: 3210,
  “currentDistanceAccuracy”: 100,
    “pairConfigurations”:
      [
      {
        “id” : “10e3Band”,
        “lowerSubcarrierIndexBoundary”:1,
        “upperSubcarrierIndexBoundary”: 1,
        “estimatedEquivalentDistance”:10000,
        “measurementCount”: 0,
        “ueConfigurable”: false,
        “measurementType”: [“mean”, “standardDeviation”] ,
        “priority”, “5”
      },
      {
        “id” : “10e2Band”,
        “lowerSubcarrierIndexBoundary”:2,
        “upperSubcarrierIndexBoundary”: 10,
        “estimatedEquivalentDistance”:1000,
        “measurementCount”: 2,
        “ueConfigurable”: false,
        “measurementType”: [“mean”, “standardDeviation”],
        “priority”, “1”
      },
      {
        “id” : “10e1band”,
        “subcarrierIndexDelta”:89,
        “estimatedEquivalentDistance”:100,
        “measurementCount”: 1,
        “ueConfigurable”: true,
        “measurementType”: [“mean”],
        “priority”, “2”
      },
      {
        “id” : “10e0Band”,
        “lowerSubcarrierIndexBoundary”:101,
        “upperSubcarrierIndexBoundary”: 3263,
        “estimatedEquivalentDistance”:10,
        “measurementCount”: 1,
        “ueConfigurable”: true,
        “measurementType”: “average”,
        “priority”, “3”
      }
    ],
  “lmfEstimatedDistance”: [3491, 3622, 3222]
  “lmfErrorRange”: 50,
  “neighborReport”: [ { ... }, { ... } ]
}
```

In the phase measurement parameters in Table 2, four different bands are created with a label corresponding to their range (10E4=10×10⁴=10000 m). The subcarrier distance can be expressed as either a pair (e.g., a lower subcarrier index boundary and an upper subcarrier index boundary) or as a differential (e.g., subcarrierIndexDelta). The UE 602 can use the subcarrier difference (or distance) to select pairs of subcarriers to measure during a symbol. In some aspects, the UE 602 measures each subcarrier of the subcarrier set pair in the symbol to reduce any doppler effects that may be present at different symbols (e.g., at different times). The measurement type can identify any suitable operation that the UE 602 can perform, such as a mean, median, average, standard deviation, floor, maximum, etc. According to some aspects, the measurement count can be frequency-based (e.g., different subcarrier set pairs), time-based (e.g., different symbols of the same subcarrier set pair), or frequency-and-time-based (e.g., different symbols of different subcarrier set pairs).

The phase measurement parameters may be presented in a different forms. For example, the phase measurement parameters may identify various subcarrier set pair configurations, but provide additional instructions such as a measurement process using a depth-first, or a breadth-first approach. In addition, the phase measurement parameters may include previous distances estimated by the LMF 606, as well as neighbor reports associated with the UE 602 (e.g., distances computed by neighbor TRPs to the UE 602).

After determining the phase measurement parameters, the LMF 606 transmits the phase measurement parameters in a measurement report 612 to the UE 602. The UE 602, upon receipt of the measurement report 612, analyzes the phase measurement parameters in the measurement report 612 and determines subcarriers received from the TRP 604 to measure at block 614. In some aspects, the LMF 606 can identify the type of reference signal (e.g., PRS, TRS PTRS, CRS, DMRS, CSI-RS, PSS, SSS, and SSB) for the UE 602 to measure and information related to the reference signal. According to some aspects, the TRP 604 may transmit the reference signals such as a PRS using various different comb structures that space apart reference signals in symbols (in the time domain) and subcarriers (in the frequency domain). The UE 602 can receive a message (e.g., from the TRP 604) indicating the comb structure of each TRP and to measure the correct PRS signals from that TRP. The UE 602, based on the phase measurement parameters, knowledge of the various comb structures, and channel conditions such as multipath, received signal strength indicator (RSSI), etc., can select the subcarrier set pairs to measure. To minimize the doppler effects, the UE 602 may measure each subcarrier set pair in the same symbol rather than at different times.

After the UE 602 determines subcarriers to measure, the UE 602 can measure the subcarriers of a downlink reference signal 616 (e.g., a PRS) from the TRP 604 at a first time. For example, the reference signal can be any suitable type of reference signal that the UE 602 is aware of, such as a PRS, SRS, TRS, PTRS, CRS, DMRS, CSI-RS, PSS, SSS, and SSB. In some aspects, the UE 602 can perform subsequent measurement of a downlink reference signal 618 from the TRP 604 at a second time. The UE 602 can also configure an order of the subcarriers to measure. In one illustrative example, the UE 602 can use the priority information in the phase measurement request to identify which subcarrier set pairs to measure and in which order.

The UE 602 generates phase measurements at block 620 based on the subcarrier measurements of the downlink reference signals 616 and 618 (e.g., PRS signals) and based on the phase measurement request from the LMF 606. In some cases, the UE may report which subcarriers pair(s) (or lane(s)) it used for reporting. Table 3 below illustrates an example of a phase measurement report with four different measurements and various parameters measured and reported by the UE 602. In the example illustrated in Table 3, the phase measurement report may be a responsive phase measurement request in Table 2. For purposes of illustration, both the phase measurement report and the phase measurement request include an identifier (“id”) to express a relationship from the phase measurement report in Table 3 to the phase measurement request in Table 2.

TABLE 3

```
{
  “dl-PRS-ID-r16”: “”,
  “nr-PhysCellId-r16”: “”,
  “nr-CellGlobalId-r16”: “”,
  “nr-ARFCN-r16”: “”,
  “nr-DL-PRS-ResourceID-r16”: “”,
  “nr-DL-PRS-ResourceSetID-r16”, “”,
  “nr-TimeStamp-r16”: “”,
  “nr-RSTD-r16”: { },
    “measuredSubcarrierPairReport”:
      [
      {
        “id” : “10e3Band”,
        “lowerSubcarrierIndex”:101,
        “upperSubcarrierIndex”: 105,
        “upperPhase”: 122,
        “lowerPhase”: 88,
        “measurementType”: “instaneous”,
        “ueConfigured”: false,
        “measurementCount”:1
        “nr-RSTD
      },
      {
        “id” : “10e3Band”,
        “subcarrierDistance”:10,
        “deltaPhase”: 43,
        “measurementType”: “mean”,
        “ueConfigured”: false,
        “measurementCount”:5
      },
      {
        “id” : “10e2Band”,
        “lowerSubcarrierIndex”:1305,
        “upperSubcarrierIndex”: 1316,
        “deltaPhase”: 63,
        “measurementType”: “median”,
        “ueConfigured”: true,
        “ueConfigurationType”: “accessCondition”,
        “numberCycles”: 15
      },
      {
        “id” : “10e1Band”,
        “lowerSubcarrierIndex”:344,
        “upperSubcarrierIndex”: 822,
        “deltaPhase”: 39,
        “measurementType”: “average”,
        “ueConfigured”: false,
        “numberCycles”: 13
      }
    ],
  “location:”: “”,
  “doppler:”: 32,
}
```

In the example illustrated in Table 3, the phase measurement report can be combined with other existing reports such as the TDoA measurement element or an RSTD measurement element. The phase measurement report may identify frequency information identifying the subcarriers used for the phase measurements in various manners. For example, the first subcarrier set pair configuration of the phase measurement report in Table 3 identifies the lower subcarrier index (e.g., the subcarrier with the lower frequency), an upper subcarrier index (e.g., the subcarrier with the higher frequency), and measurements for each subcarrier. In this case, the LMF 606 can receive the subcarrier set pair report and determine a phase difference (Δϕ) based on a difference of the upper phase and the lower phase, which can then be converted to a distance using equation 10 above. In another illustrative example, the UE 602 can determine the phase difference (Δϕ), and as noted in the second report (e.g., the second “10e3Band” entry), the UE 602 can report the subcarrier index difference (or subcarrier distance) and the phase difference itself. Moreover, the second “10e3Band” entry in Table 3 indicates that the phase measurement was performed five times and a mean of the phase measurements is reported to the LMF 606.

The third phase measurement corresponding to the identifier of 10e2Band indicates that the UE reconfigured the measurement based on an access condition. For example, the TRP 604 may not have transmitted on a particular frequency due to an unforeseen event, and the UE accordingly reconfigures the measurement because access to the subcarrier is unavailable. Rather than wait for another potential measurement and consume power, the UE 602 may elect to select another carrier. In this example, the subcarrier set pair configuration identifies a subcarrier difference (or distance) of 8 (e.g., a lower subcarrier index boundary of 2 and an upper subcarrier index boundary of 10), but the UE 602 selects subcarriers that are spaced apart 11 subcarriers (lower subcarrier index 1305 and upper subcarrier index 1316).

In some aspects, the UE 602 may be able to identify a number of cycles (e.g., Nₖ and Nₖ₋ₘ) of subcarriers and a cycle differential (e.g., Nₘ) between the subcarriers based on information concurrently provided to or deduced by the UE 602. For example, the UE 602 may determine that a current phase measurement of a narrow subcarrier set pair with a longer equivalent wavelength can be used to determine a number of cycles associated with a phase measurement with a subcarrier set pair having a shorter equivalent wavelength.

Various permutations of the phase measurements can be configured. In one illustrative example, the UE 602 may generate and send back phase measurements that summarizes all measurements in a particular subcarrier set pair configuration. The phase measurements can also include other information such as RSSIs, multipath fading information, information associated with clock drift that affects phase measurements, and the like.

After the UE 602 generates the phase measurements, the UE 602 may transmit a measurement report 622 to the LMF 606. In response to the LMF 606 receiving the measurement report 622, the LMF 606 determines a location of the UE 602 at block 624. For example, the LMF 606 may have determined a location of the UE 602 with respect to two other TRPs (not shown). Based on determining a distance from the TRP 604 to the UE 602 and a fixed position of the TRPs, the LMF 606 can calculate a location of the UE 602. The accuracy of the distance from the TRP 604 to the UE 602 is based on the equivalent wavelength λ_{Δ}^{m} of a particular subcarrier set pair and a measurement capability of the UE 602. For example, if the UE 602 can only provide 36 different measurements and, at the largest equivalent wavelength of 10 km, the UE 602 can at best measure at an accuracy of 300 m, or a range of ±150 m. For the shortest equivalent wavelength of 3 m, the same UE can at best measure at an accuracy of 8.33 cm, or a range of ±4.16 cm.

After the LMF 606 determines a location of the UE 602, the LMF 606 transmits a measurement request or a location report 626 to the UE 602. In some aspects, the LMF 606 can determine a location based on the initial measurements and can further request additional measurements to refine the accuracy of the location of the UE 602. In other aspects, the LMF 606 can transmit a location report that identifies a location and a range of that location (e.g., ±10 m, ±4 cm, etc.). The LMF 606 is able to identify a position of the UE 602 with centimeter-level accuracy and can be determined from both indoor and outdoor environments.

FIG. 7A is an illustration of wireless communication system 700 and different subcarrier set pair configurations for measuring phase and determining a location from a transmitting device, according to some aspects of the present disclosure. In some aspects, a TRP 710 is configured to transmit a reference signal (e.g., PRS, TRS PTRS, CRS, DMRS, CSI-RS, PSS, SSS, and SSB) using different subcarriers and the reference signals can be transmitted in a pattern such as a comb structure. In some aspects, the TRP 710 can group different subcarrier set pair configuration based on a difference (or a distance) of the subcarrier indexes.

The TRP 710 in this example has created a narrow subcarrier set pair configuration 712 having a lower subcarrier boundary of 1 and an upper subcarrier boundary of 10, or a maximum difference of 9. In this case, the subcarriers in this group will have a minimum equivalent distance of approximately 1,000 m and a maximum equivalent distance of approximately 10,000 m. The subcarrier set pair configuration 714 has a minimum equivalent distance of approximately 100 m and a maximum equivalent distance of approximately 1,000 m. The subcarrier set pair configuration 716 has a minimum equivalent distance of approximately 10 m and a maximum equivalent distance of approximately 1,000 m. The subcarrier set pair configuration 717 has a minimum equivalent distance of approximately 3 m based on the widest configuration noted above and a maximum equivalent distance of approximately 10 m.

FIG. 7B is an illustration of wireless communication system 750 and combining phase measurements of different subcarrier set pair configurations to improve determining a location from a transmitting device. In some aspects, measurements provided by different subcarrier set pair configurations can be combined to more accurately determine a location within a region 770. In the wireless communication system 750, the UE 760 is positioned within a region associated with either the subcarrier set pair configuration 712 or the subcarrier set pair configuration 714. The LMF can instruct the UE 760 to perform various measurements using any of the subcarrier set pair configurations. For example, the LMF can determine that distances to the UE 760 determined using the subcarrier set pair configuration 712 or the subcarrier set pair configuration 714 at least partially overlap and the LMF may identify an approximate distance to the UE 760 based on the accuracy of the subcarrier set pair configuration 714. In some aspects, the LMF can also combine the phase measurement with other distance estimation techniques such as RSTD, TDoA, etc.

The LMF may transmit a measurement report to the UE 760 that indicates an estimated distance from the TRP 710 and the UE 760 can determine a number of cycles associated with each subcarrier of a wider subcarrier configuration pair. The UE 760 can measure the phase difference of the wider subcarrier configuration pair and the UE 760 or LMF can determine a location of the UE 760 within region 770 because the number of cycles is not unknown. For example, the UE 760 or LMF could identify the number of cycles (e.g., Nₖ and Nₖ₋ₘ) for a subcarrier set pair of a wider subcarrier configuration (e.g., having a shorter equivalent wavelength) and then determine the distance using Equation 8. Based on the shorter equivalent wavelength of the wider subcarrier set pair, the UE or the LMF can identify a more precise location within the region 770. In this case, the different measurements could be simultaneous or sequential.

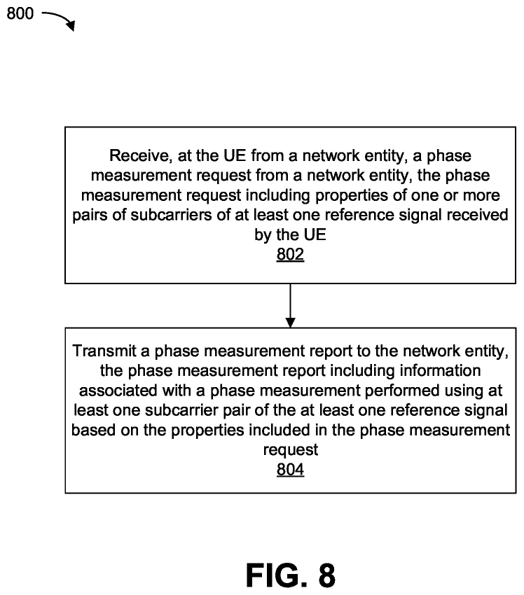

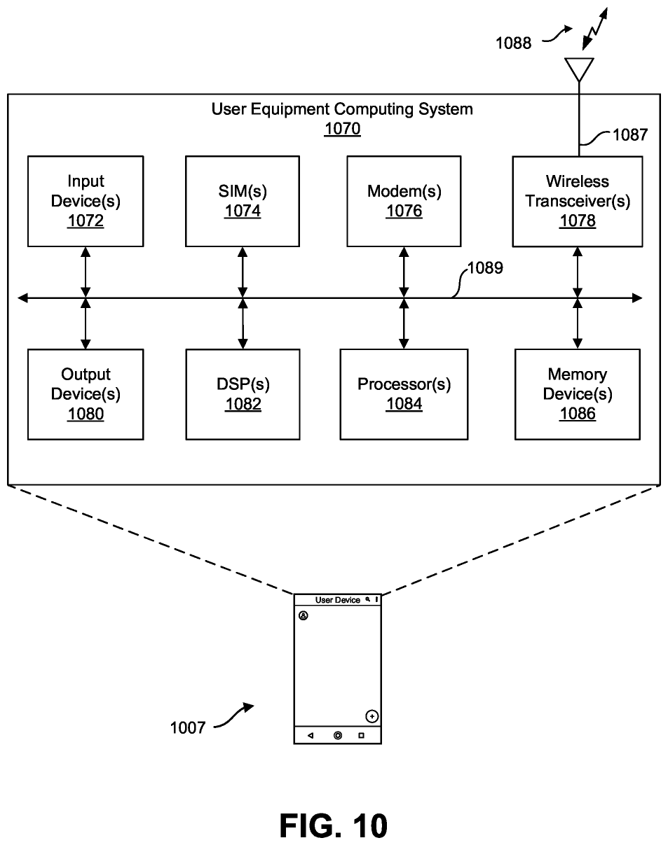

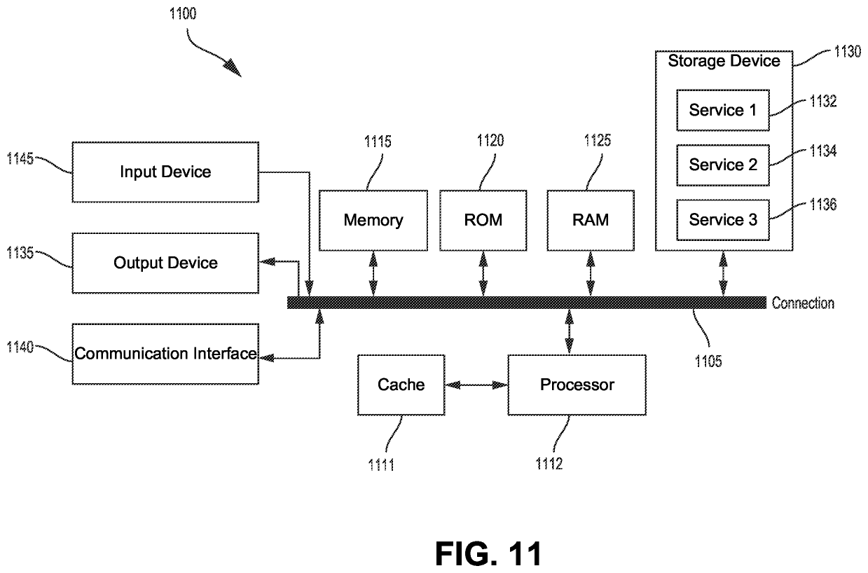

FIG. 8 is a flow chart illustrating an example of a process 800 for wireless communications. For instance, the process 800 can be used for estimating distances to a UE, according to the systems and techniques described herein. The process 800 can be performed by a computing device or apparatus, such as a wireless communications device (e.g., a UE), or a component or system (e.g., a chipset) of the wireless communication device. The operations of the process 800 may be implemented as software components that are executed and run on one or more processors (e.g., processor(s) 1084 of FIG. 10, processor 1112 of FIG. 11, or other processor(s)). Further, the transmission and reception of signals by the wireless communications device in the process 800 may be enabled, for example, by one or more antennas (e.g., antenna 1087 of FIG. 10) and/or one or more transceivers (e.g., wireless transceiver(s) 1178 of FIG. 10).

At block 802, the computing device (or component thereof) receives a phase measurement request from a network entity, the phase measurement request including properties of one or more pairs of subcarrier sets of at least one reference signal received by the UE at block 802. As described above, a subcarrier set includes at least one subcarrier. For instance, as noted above, one example of a “set of subcarriers” is a set with a single subcarrier. In such cases, a pair of subcarriers includes two subcarriers (as each set would include a single subcarrier). In some examples, “X subcarriers” (e.g., consecutive subcarriers) can be included in a set of subcarriers, in which case the wireless communication device can derive a single phase measurement for the set of subcarriers including X subcarriers. The measurement report can include the measured phase difference(s) between the at least one subcarrier set pair or can include the measured phases (in which case the first network entity or other network entity can determine the phase difference(s)). The respective size of each specific set of subcarrier set pairs is based on at least one of subcarrier spacing between the specific set of subcarrier set pairs, bandwidth of the specific set of subcarrier set pairs, frequency of the specific set of subcarrier set pairs, or frequency band specific set of subcarrier set pairs.

In some aspects, the properties in the phase measurement request may be configured by a network entity, such as an LMF. In one illustrative example, the properties included in the phase measurement request comprise an indication of a specific set of subcarrier set pairs of the at least one reference signal to use for performing phase measurements. The properties included in the phase measurement request comprise number of subcarrier set pairs of the at least one reference signal to use for performing phase measurements. In another example, the properties included in the phase measurement request comprise a respective size of each specific set of subcarrier set pairs of the at least one reference signal. A subcarrier set includes at least one subcarrier. The phase measurement request identifies a range of subcarriers that can be used as subcarrier set pairs for performing phase measurements. In some aspects, the LMF can identify a priority of subcarrier set pairs and the phase measurement request may include a priority order of a plurality of subcarrier set pairs of the at least one reference signal for performing phase measurements.

According to some examples, the computing device (or component thereof) may select a set of subcarrier set pairs of the at least one reference signal based on the properties included in the phase measurement request. Based on the selected subcarrier sets, the computing device (or component thereof) may then measure a phase difference between each subcarrier in the set of subcarrier set pairs.

At block 804, the computing device (or component thereof) transmits a phase measurement report to the network entity, the phase measurement report including information associated with a phase measurement performed using at least one subcarrier pair of the at least one reference signal based on the properties included in the phase measurement request at block 804. The phase measurement report includes frequency information of the at least one subcarrier set pair. The phase measurement report includes information associated with a phase difference between the at least one subcarrier set pair of the at least one reference signal. The phase measurement report includes information associated with a wavelength cycle difference between a first number of wavelength cycles of a first subcarrier of the at least one subcarrier set pair and a second number of wavelength cycles of a second subcarrier of the at least one subcarrier set pair. The phase measurement report includes information associated with a phase difference between the at least one subcarrier set pair of the at least one reference signal and information associated with a wavelength cycle difference between a first number of wavelength cycles of a first subcarrier of the at least one subcarrier set pair and a second number of wavelength cycles of a second subcarrier of the at least one subcarrier set pair. The phase measurement request identifies a measurement type associated the at least one subcarrier set pair. The measurement type comprises at least one of a median, a mean, or a standard deviation. The phase measurement report including information associated with a phase measurement performed using at least one subcarrier set pair of the at least one reference signal based on the properties included in the phase measurement request. The phase measurement report can be configured based on measurements at the UE.

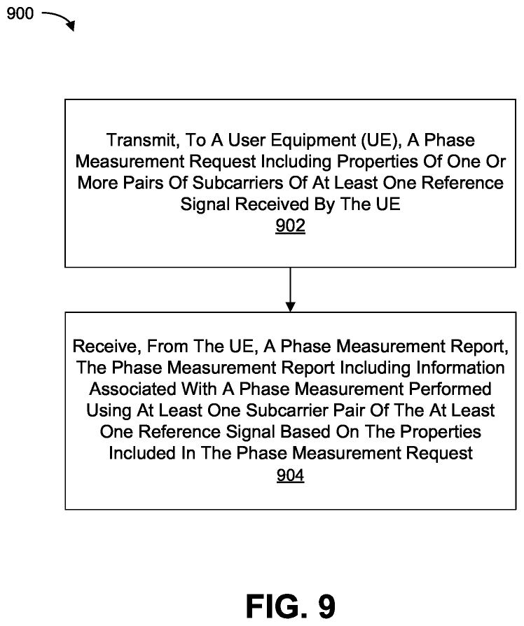

FIG. 9 is a flow chart illustrating an example of a process 900 for wireless communications. For instance, the process 900 can be used for estimating distances to a UE, according to the systems and techniques described herein. The process 900 can be performed a network entity (e.g., an eNB, a gNB, a location server such as an LMF, or a portion thereof, such as one or more of a CU, a DU, a RU, a Near-RT RIC, or a Non-RT RIC.) or by a component or system (e.g., a chipset) of the network entity. The operations of the process 900 may be implemented as software components that are executed and run on one or more processors (e.g., processor 1112 of FIG. 11 or other processor(s)). Further, the transmission and reception of signals by the wireless communications device in the process 900 may be enabled, for example, by one or more antennas and/or one or more transceivers (e.g., wireless transceiver(s)).

According to some examples, the network entity (or component thereof) may transmit a phase measurement request including properties of one or more pairs of subcarriers of at least one reference signal received by the UE at block 902. The properties can include various information identified by the network entity (or component thereof). In one illustrative aspect, the properties included in the phase measurement request comprise an indication of a specific set of subcarrier set pairs of the at least one reference signal to use for performing phase measurements. In another example, the properties included in the phase measurement request comprise a respective size of each specific set of subcarrier set pairs of the at least one reference signal. The respective size of each specific set of subcarrier set pairs is based on at least one of subcarrier spacing between the specific set of subcarrier set pairs, bandwidth of the specific set of subcarrier set pairs, frequency of the specific set of subcarrier set pairs, or frequency band specific set of subcarrier set pairs. The phase measurement request identifies a range of subcarriers that can be used as subcarrier set pairs for performing phase measurements. Additionally or alternatively, the properties included in the phase measurement request comprise number of subcarrier set pairs of the at least one reference signal to use for performing phase measurements. The network entity (or component thereof) can use the properties of the one or more pairs of subcarriers to identify resources for the UE to measure.

In some aspects, the network entity (or component thereof) may determine a priority order of a plurality of subcarrier set pairs of the at least one reference signal for performing phase measurements. Based on the priority order, the UE can select the subcarriers to measure. In some cases, the order is explicit (e.g., a rank) or may be implicit (e.g., an order of the list, etc.).

In some aspects, the network entity (or component thereof) may also receive a phase measurement report including information associated with a phase measurement performed using at least one subcarrier pair of the at least one reference signal based on the properties included in the phase measurement request. The phase measurement report has various configurations and can, for example, include frequency information of the at least one subcarrier set pair. In other examples, the phase measurement report includes information associated with a phase difference between the at least one subcarrier set pair of the at least one reference signal. The phase measurement report includes information associated with a wavelength cycle difference between a first number of wavelength cycles of a first subcarrier of the at least one subcarrier set pair and a second number of wavelength cycles of a second subcarrier of the at least one subcarrier set pair. Additionally or alternatively, the phase measurement report includes information associated with a phase difference between the at least one subcarrier set pair of the at least one reference signal and information associated with a wavelength cycle difference between a first number of wavelength cycles of a first subcarrier of the at least one subcarrier set pair and a second number of wavelength cycles of a second subcarrier of the at least one subcarrier set pair.

In some cases, the phase measurement request may identify a measurement type associated the at least one subcarrier set pair. The measurement type comprises at least one of a median, a mean, or a standard deviation. The phase measurement report can also include information associated with a phase measurement performed using at least one subcarrier set pair of the at least one reference signal based on the properties included in the phase measurement request. The phase measurement report can be configured based on measurements and other information determined by the UE.

In some aspects, the network entity (or component thereof) may determine a distance to the device from at least one TRP based on the phase measurement report. Based on the subcarriers and different phase measurements, the network entity (or component thereof) can determine the location of the device within centimeters. After determining the distance, the network entity (or component thereof) may determine a location of the device based at least in part on the distance from the device to the TRP. For example, the network entity (or component thereof) may use distances from other TRPs to triangulate a location of the device within centimeters. The network entity (or component thereof) may also combine the distance with other types of location measurements (e.g., TDoA, etc.).

FIG. 10 illustrates an example of a computing system 1070 of a user equipment (UE) 1007. In some examples, the UE 1007 can include a mobile phone, router, tablet computer, laptop computer, tracking device, wearable device (e.g., a smart watch, glasses, an XR device, etc.), IoT device, and/or other device used by a user to communicate over a wireless communications network. The computing system 1070 includes software and hardware components that can be electrically coupled via a bus 1089 (or may otherwise be in communication, as appropriate). For example, the computing system 1070 includes one or more processors 1084. The one or more processors 1084 can include one or more CPUs, ASICs, FPGAs, APs, GPUs, VPUs, NSPs, microcontrollers, dedicated hardware, any combination thereof, and/or other processing device or system. The bus 1089 can be used by the one or more processors 1084 to communicate between cores and/or with the one or more memory devices 1086.

The computing system 1070 may also include one or more memory devices 1086, one or more digital signal processors (DSPs) 1082, one or more subscriber identity modules (SIMs) 1074, one or more modems 1076, one or more wireless transceivers 1078, an antenna 1087, one or more input devices 1072 (e.g., a camera, a mouse, a keyboard, a touch sensitive screen, a touch pad, a keypad, a microphone, and/or the like), and one or more output devices 1080 (e.g., a display, a speaker, a printer, and/or the like). As used herein, the one or more wireless transceivers 1078 can include one or more receiving devices (e.g., receivers) and/or one or more transmitting devices (e.g., transmitters).

The one or more wireless transceivers 1078 can transmit and receive wireless signals (e.g., signal 1088) via antenna 1087 to and from one or more other devices, such as one or more other UEs, network devices or entities (e.g., base stations such as eNBs and/or gNBs, WiFi routers, etc.), cloud networks, and/or the like. As described herein, the one or more wireless transceivers 1078 can include a combined transmitter/receiver, discrete transmitters, discrete receivers, or any combination thereof. In some examples, the computing system 1070 can include multiple antennae. The wireless signal 1088 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 1078 may include a radio frequency (RF) front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 1088 into a baseband or intermediate frequency and can convert the RF signals to the digital domain.

In some cases, the computing system 1070 can include a coding-decoding device (or CODEC) configured to encode and/or decode data transmitted and/or received using the one or more wireless transceivers 1078. In some cases, the computing system 1070 can include an encryption-decryption device or component configured to encrypt and/or decrypt data (e.g., according to the AES and/or DES standard) transmitted and/or received by the one or more wireless transceivers 1078.

The one or more SIMs 1074 can each securely store an International Mobile Subscriber Identity (IMSI) number and a related key assigned to the user of the UE 1007. The IMSI and the key can be used to identify and authenticate the subscriber when accessing a network provided by a network service provider or operator associated with the one or more SIMs 1074. The one or more modems 1076 can modulate one or more signals to encode information for transmission using the one or more wireless transceivers 1078. The one or more modems 1076 can also demodulate signals received by the one or more wireless transceivers 1078 in order to decode the transmitted information. In some examples, the one or more modems 1076 can include a 4G (or LTE) modem, a 5G (or NR) modem, a Bluetooth™ modem, a modem configured for vehicle-to-everything (V2X) communications, and/or other types of modems. In some examples, the one or more modems 1076 and the one or more wireless transceivers 1078 can be used for communicating data for the one or more SIMs 1074.

The computing system 1070 can also include (and/or be in communication with) one or more non-transitory machine-readable storage media or storage devices (e.g., one or more memory devices 1086), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 1086 and executed by the one or more processor(s) 1084 and/or the one or more DSPs 1082. The computing system 1070 can also include software elements (e.g., located within the one or more memory devices 1086), including, for example, an operating system, device drivers, executable libraries, and/or other code, such as one or more application programs, which may comprise computer programs implementing the functions provided by various aspects, and/or may be designed to implement methods and/or configure systems, as described herein.

In some aspects, the UE 1007 can include means for performing operations described herein. The means can include one or more of the components of the computing system 1070. For example, the means for performing operations described herein may include one or more of input device(s) 1072, SIM(s) 1074, modems(s) 1076, wireless transceiver(s) 1078, output device(s) (1080), DSP(s) 1082, processors (1084), memory device(s) 1086, and/or antenna(s) 1087.

In some aspects, the UE 1007 can include means for receiving resource configuration information, wherein the resource configuration information is based on a threshold associated with the apparatus, and wherein the resource configuration information indicates a time-gap for transmission of Sounding Reference Signal (SRS) resources. In some aspects, the UE 1007 may further include means for transmitting one or more SRS resources based on the time-gap indicated by the resource configuration information.

In some examples, the means for receiving can include the one or more wireless transceivers 1078, the one or more modems 1076, the one or more SIMs 1074, the one or more processors 1084, the one or more DSPs 1082, the one or more memory devices 1086, any combination thereof, or other component(s) of the client device. In some examples, the means for determining can include the one or more processors 1084, the one or more DSPs 1082, the one or more memory devices 1086, any combination thereof, or other component(s) of the client device. In some examples, the means for transmitting can include the one or more wireless transceivers 1078, the one or more modems 1076, the one or more SIMs 1074, the one or more processors 1084, the one or more DSPs 1082, the one or more memory devices 1086, any combination thereof, or other component(s) of the client device.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), DSPs, central processing units (CPUs), and/or other suitable electronic circuits), and/or can include and/or be implemented using computer software, firmware, or any combination thereof, to perform the various operations described herein.

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1100 includes at least one processing unit (CPU or processor) 1110 and connection 1105 that couples various system components including system memory 1115, such as read-only memory (ROM) 1120 and random-access memory (RAM) 1125 to processor 1110. Computing system 1100 can include a cache 1111 of high-speed memory connected directly with, in close proximity to, or integrated as part of processor 1110.

Processor 1110 can include any general-purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1140 may also include one or more GNSS receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative examples of the disclosure include:

Aspect 1: A method for wireless communication at a user equipment (UE), comprising: receiving, at the UE from a network entity, a phase measurement request from a network entity, the phase measurement request including properties of one or more pairs of subcarrier sets of at least one reference signal received by the UE, wherein a subcarrier set includes at least one subcarrier; and transmitting a phase measurement report to the network entity, the phase measurement report including information associated with a phase measurement performed using at least one subcarrier set pair of the at least one reference signal based on the properties included in the phase measurement request.

Aspect 2: The method of Aspect 1, wherein the properties included in the phase measurement request comprise number of subcarrier set pairs of the at least one reference signal to use for performing phase measurements.

Aspect 3: The method of any of Aspects 1 to 2, wherein the properties included in the phase measurement request comprise an indication of a specific set of subcarrier set pairs of the at least one reference signal to use for performing phase measurements.

Aspect 4: The method of any of Aspects 1 to 3, wherein the properties included in the phase measurement request comprise a respective size of each specific set of subcarrier set pairs of the at least one reference signal.

Aspect 5: The method of any of Aspects 1 to 4, wherein the respective size of each specific set of subcarrier set pairs is based on at least one of subcarrier spacing between each specific set of subcarrier set pairs, bandwidth of each specific set of subcarrier set pairs, frequency of each specific set of subcarrier set pairs, or frequency band specific set of subcarrier set pairs.

Aspect 6: The method of any of Aspects 1 to 5, wherein the phase measurement request identifies a range of subcarriers that can be used as subcarrier set pairs for performing phase measurements.

Aspect 7: The method of any of Aspects 1 to 6, wherein the phase measurement request includes a priority order of a plurality of subcarrier set pairs of the at least one reference signal for performing phase measurements.

Aspect 8: The method of claim of any of Aspects 1 to 7, further comprising: selecting a set of subcarrier set pairs of the at least one reference signal based on the properties included in the phase measurement request; and measuring a phase difference between each subcarrier in the set of subcarrier set pairs.

Aspect 9: The method of any of Aspects 1 to 8, wherein the phase measurement report includes frequency information of the at least one subcarrier set pair.

Aspect 10: The method of any of Aspects 1 to 9, wherein the phase measurement report includes information associated with a phase difference between the at least one subcarrier set pair of the at least one reference signal.

Aspect 11: The method of any of Aspects 1 to 10, wherein the phase measurement report includes information associated with a wavelength cycle difference between a first number of wavelength cycles of a first subcarrier of the at least one subcarrier set pair and a second number of wavelength cycles of a second subcarrier of the at least one subcarrier set pair.

Aspect 12: The method of any of Aspects 1 to 11, wherein the phase measurement report includes information associated with a phase difference between the at least one subcarrier set pair of the at least one reference signal and information associated with a wavelength cycle difference between a first number of wavelength cycles of a first subcarrier of the at least one subcarrier set pair and a second number of wavelength cycles of a second subcarrier of the at least one subcarrier set pair.

Aspect 13: The method of any of Aspects 1 to 12, wherein the phase measurement request identifies a measurement type associated the at least one subcarrier set pair, wherein the measurement type comprises at least one of a median, a mean, or a standard deviation.

Aspect 14: A method for wireless communication at a network entity, comprising: transmitting, to a user equipment (UE), a phase measurement request including properties of one or more pairs of subcarrier sets of at least one reference signal received by the UE; and receiving, from the UE, a phase measurement report, the phase measurement report including information associated with a phase measurement performed using at least one subcarrier set pair of the at least one reference signal based on the properties included in the phase measurement request.

Aspect 15: The method of Aspect 14, wherein the properties included in the phase measurement request comprise number of subcarrier set pairs of the at least one reference signal to use for performing phase measurements.

Aspect 16: The method of any of Aspects 14 to 15, wherein the properties included in the phase measurement request comprise an indication of a specific set of subcarrier set pairs of the at least one reference signal to use for performing phase measurements.

Aspect 17: The method of any of Aspects 14 to 16, wherein the properties included in the phase measurement request comprise a respective size of each specific set of subcarrier set pairs of the at least one reference signal.

Aspect 18: The method of any of Aspects 14 to 17, wherein the respective size of each specific set of subcarrier set pairs is based on at least one of subcarrier spacing between each specific set of subcarrier set pairs, bandwidth of each specific set of subcarrier set pairs, frequency of each specific set of subcarrier set pairs, or frequency band specific set of subcarrier set pairs.

Aspect 19: The method of any of Aspects 14 to 18, wherein the phase measurement request identifies a range of subcarriers that can be used as subcarrier set pairs for performing phase measurements.

Aspect 20: The method of any of Aspects 14 to 19, further comprising: determining a priority order of a plurality of subcarrier set pairs of the at least one reference signal for performing phase measurements.

Aspect 21: The method of claim of any of Aspects 14 to 20, further comprising: determining a distance to the UE from at least one transmission-reception point (TRP) based on the phase measurement report; and determining a location of the UE based at least in part on the distance from the UE to the TRP.

Aspect 22: The method of any of Aspects 14 to 21, wherein the phase measurement report includes frequency information of the at least one subcarrier set pair.

Aspect 23: The method of any of Aspects 14 to 22, wherein the phase measurement report includes information associated with a phase difference between the at least one subcarrier set pair of the at least one reference signal.

Aspect 24: The method of any of Aspects 14 to 23, wherein the phase measurement report includes information associated with a wavelength cycle difference between a first number of wavelength cycles of a first subcarrier of the at least one subcarrier set pair and a second number of wavelength cycles of a second subcarrier of the at least one subcarrier set pair.

Aspect 25: The method of any of Aspects 14 to 24, wherein the phase measurement report includes information associated with a phase difference between the at least one subcarrier set pair of the at least one reference signal and information associated with a wavelength cycle difference between a first number of wavelength cycles of a first subcarrier of the at least one subcarrier set pair and a second number of wavelength cycles of a second subcarrier of the at least one subcarrier set pair.

Aspect 26: The method of any of Aspects 14 to 25, wherein the phase measurement request identifies a measurement type associated the at least one subcarrier set pair, wherein the measurement type comprises at least one of a median, a mean, or a standard deviation.

Aspect 27: An apparatus for wireless communications, comprising: a memory; and one or more processors coupled to the memory, the one or more processors configured to: receive, from a network entity, a phase measurement request from a network entity, the phase measurement request including properties of one or more pairs of subcarrier sets of at least one reference signal received by the apparatus, wherein a subcarrier set includes at least one subcarrier; and transmit a phase measurement report to the network entity, the phase measurement report including information associated with a phase measurement performed use at least one subcarrier set pair of the at least one reference signal based on the properties included in the phase measurement request.

Aspect 28: The apparatus of Aspect 27, wherein the properties included in the phase measurement request comprise number of subcarrier set pairs of the at least one reference signal to use for performing phase measurements.

Aspect 29: The apparatus of any of Aspects 27 to 28, wherein the properties included in the phase measurement request comprise an indication of a specific set of subcarrier set pairs of the at least one reference signal to use for performing phase measurements.

Aspect 30: The apparatus of any of Aspects 27 to 29, wherein the properties included in the phase measurement request comprise a respective size of each specific set of subcarrier set pairs of the at least one reference signal.

Aspect 31: The apparatus of any of Aspects 27 to 30, wherein the respective size of each specific set of subcarrier set pairs is based on at least one of subcarrier spacing between each specific set of subcarrier set pairs, bandwidth of each specific set of subcarrier set pairs, frequency of each specific set of subcarrier set pairs, or frequency band specific set of subcarrier set pairs.

Aspect 32: The apparatus of any of Aspects 27 to 31, wherein the phase measurement request identifies a range of subcarriers that can be used as subcarrier set pairs for performing phase measurements.

Aspect 33: The apparatus of any of Aspects 27 to 32, wherein the phase measurement request includes a priority order of a plurality of subcarrier set pairs of the at least one reference signal for performing phase measurements.

Aspect 34: The apparatus of any of Aspects 27 to 33, wherein the one or more processors are configured to: select a set of subcarrier set pairs of the at least one reference signal based on the properties included in the phase measurement request; and measure a phase difference between each subcarrier in the set of subcarrier set pairs.

Aspect 35: The apparatus of any of Aspects 27 to 34, wherein the phase measurement report includes frequency information of the at least one subcarrier set pair.

Aspect 36: The apparatus of any of Aspects 27 to 35, wherein the phase measurement report includes information associated with a phase difference between the at least one subcarrier set pair of the at least one reference signal.

Aspect 37: The apparatus of any of Aspects 27 to 36, wherein the phase measurement report includes information associated with a wavelength cycle difference between a first number of wavelength cycles of a first subcarrier of the at least one subcarrier set pair and a second number of wavelength cycles of a second subcarrier of the at least one subcarrier set pair.

Aspect 38: The apparatus of any of Aspects 27 to 37, wherein the phase measurement report includes information associated with a phase difference between the at least one subcarrier set pair of the at least one reference signal and information associated with a wavelength cycle difference between a first number of wavelength cycles of a first subcarrier of the at least one subcarrier set pair and a second number of wavelength cycles of a second subcarrier of the at least one subcarrier set pair.

Aspect 39: The apparatus of any of Aspects 27 to 38, wherein the phase measurement request identifies a measurement type associated the at least one subcarrier set pair and the phase measurement request identifies a measurement type associated the at least one subcarrier set pair.

Aspect 40: An apparatus for wireless communications, comprising: a memory; and one or more processors coupled to the memory, the one or more processors configured to: transmit, to a user equipment (UE), a phase measurement request including properties of one or more pairs of subcarrier sets of at least one reference signal received by the UE; and receive, from the UE, a phase measurement report, the phase measurement report including information associated with a phase measurement performed use at least one subcarrier set pair of the at least one reference signal based on the properties included in the phase measurement request.

Aspect 41: The apparatus of Aspect 40, wherein the properties included in the phase measurement request comprise number of subcarrier set pairs of the at least one reference signal to use for performing phase measurements.

Aspect 42: The apparatus of any of Aspects 40 to 41, wherein the properties included in the phase measurement request comprise an indication of a specific set of subcarrier set pairs of the at least one reference signal to use for performing phase measurements.

Aspect 43: The apparatus of any of Aspects 40 to 42, wherein the properties included in the phase measurement request comprise a respective size of each specific set of subcarrier set pairs of the at least one reference signal.

Aspect 44: The apparatus of any of Aspects 40 to 43, wherein the respective size of each specific set of subcarrier set pairs is based on at least one of subcarrier spacing between each specific set of subcarrier set pairs, bandwidth of each specific set of subcarrier set pairs, frequency of each specific set of subcarrier set pairs, or frequency band specific set of subcarrier set pairs.

Aspect 45: The apparatus of any of Aspects 40 to 44, wherein the phase measurement request identifies a range of subcarriers that can be used as subcarrier set pairs for performing phase measurements.

Aspect 46: The apparatus of any of Aspects 40 to 45, wherein the one or more processors are configured to: determine a priority order of a plurality of subcarrier set pairs of the at least one reference signal for perform phase measurements.

Aspect 47: The apparatus of any of Aspects 40 to 46, wherein the one or more processors are configured to: determine a distance to the UE from at least one transmission-reception point (TRP) based on the phase measurement report; and determine a location of the UE based at least in part on the distance from the UE to the TRP.

Aspect 48: The apparatus of any of Aspects 40 to 47, wherein the phase measurement report includes frequency information of the at least one subcarrier set pair.

Aspect 49: The apparatus of any of Aspects 40 to 48, wherein the phase measurement report includes information associated with a phase difference between the at least one subcarrier set pair of the at least one reference signal.

Aspect 50: The apparatus of any of Aspects 40 to 49, wherein the phase measurement report includes information associated with a wavelength cycle difference between a first number of wavelength cycles of a first subcarrier of the at least one subcarrier set pair and a second number of wavelength cycles of a second subcarrier of the at least one subcarrier set pair.

Aspect 51: The apparatus of any of Aspects 40 to 50, wherein the phase measurement report includes information associated with a phase difference between the at least one subcarrier set pair of the at least one reference signal and information associated with a wavelength cycle difference between a first number of wavelength cycles of a first subcarrier of the at least one subcarrier set pair and a second number of wavelength cycles of a second subcarrier of the at least one subcarrier set pair.

Aspect 52: The apparatus of any of Aspects 40 to 51, wherein the phase measurement request identifies a measurement type associated the at least one subcarrier set pair and the phase measurement request identifies a measurement type associated the at least one subcarrier set pair.

Aspect 53: At least one non-transitory computer-readable medium containing instructions which, when executed by one or more processors, cause the one or more processors to perform a method according to any of Aspects 1 to 13.

Aspect 54: An apparatus comprising means for performing a method according to any of Aspects 1 to 13.

Aspect 55: At least one non-transitory computer-readable medium containing instructions which, when executed by one or more processors, cause the one or more processors to perform a method according to any of Aspects 14 to 26.

Aspect 56: An apparatus comprising means for performing a method according to any of Aspects 14 to 26.

What is claimed is:

1. A method for wireless communication at a user equipment (UE), comprising:
receiving, at the UE from a network entity, a phase measurement request from a network entity, the phase measurement request including properties of one or more pairs of subcarrier sets of at least one reference signal received by the UE, wherein a subcarrier set includes at least one subcarrier; and
transmitting a phase measurement report to the network entity, the phase measurement report including information associated with a phase measurement performed using at least one subcarrier set pair of the at least one reference signal based on the properties included in the phase measurement request.

2. The method of claim 1, wherein the properties included in the phase measurement request comprise number of subcarrier set pairs of the at least one reference signal to use for performing phase measurements.

3. The method of claim 1, wherein the properties included in the phase measurement request comprise an indication of a specific set of subcarrier set pairs of the at least one reference signal to use for performing phase measurements.

4. The method of claim 3, wherein the properties included in the phase measurement request comprise a respective size of each specific set of subcarrier set pairs of the at least one reference signal.

5. The method of claim 4, wherein the respective size of each specific set of subcarrier set pairs is based on at least one of subcarrier spacing between each specific set of subcarrier set pairs, bandwidth of each specific set of subcarrier set pairs, frequency of each specific set of subcarrier set pairs, or frequency band specific set of subcarrier set pairs.

6. The method of claim 1, wherein the phase measurement request identifies a range of subcarriers that can be used as subcarrier set pairs for performing phase measurements.

7. The method of claim 1, wherein the phase measurement request includes a priority order of a plurality of subcarrier set pairs of the at least one reference signal for performing phase measurements.

8. The method of claim of claim 1, further comprising:
selecting a set of subcarrier set pairs of the at least one reference signal based on the properties included in the phase measurement request; and
measuring a phase difference between each subcarrier in the set of subcarrier set pairs.

9. The method of claim 1, wherein the phase measurement report includes frequency information of the at least one subcarrier set pair.

10. The method of claim 1, wherein the phase measurement report includes information associated with a phase difference between the at least one subcarrier set pair of the at least one reference signal.

11. The method of claim 1, wherein the phase measurement report includes information associated with a wavelength cycle difference between a first number of wavelength cycles of a first subcarrier of the at least one subcarrier set pair and a second number of wavelength cycles of a second subcarrier of the at least one subcarrier set pair.

12. The method of claim 1, wherein the phase measurement report includes information associated with a phase difference between the at least one subcarrier set pair of the at least one reference signal and information associated with a wavelength cycle difference between a first number of wavelength cycles of a first subcarrier of the at least one subcarrier set pair and a second number of wavelength cycles of a second subcarrier of the at least one subcarrier set pair.

13. The method of claim 1, wherein the phase measurement request identifies a measurement type associated the at least one subcarrier set pair, wherein the measurement type comprises at least one of a median, a mean, or a standard deviation.

14. A method for wireless communication at a network entity, comprising:
transmitting, to a user equipment (UE), a phase measurement request including properties of one or more pairs of subcarrier sets of at least one reference signal received by the UE; and
receiving, from the UE, a phase measurement report, the phase measurement report including information associated with a phase measurement performed using at least one subcarrier set pair of the at least one reference signal based on the properties included in the phase measurement request.

15. The method of claim 14, wherein the properties included in the phase measurement request comprise number of subcarrier set pairs of the at least one reference signal to use for performing phase measurements.

16. The method of claim 14, wherein the properties included in the phase measurement request comprise an indication of a specific set of subcarrier set pairs of the at least one reference signal to use for performing phase measurements.

17. The method of claim 14, wherein the properties included in the phase measurement request comprise a respective size of each specific set of subcarrier set pairs of the at least one reference signal.

18. The method of claim 17, wherein the respective size of each specific set of subcarrier set pairs is based on at least one of subcarrier spacing between each specific set of subcarrier set pairs, bandwidth of each specific set of subcarrier set pairs, frequency of each specific set of subcarrier set pairs, or frequency band specific set of subcarrier set pairs.

19. The method of claim 14, wherein the phase measurement request identifies a range of subcarriers that can be used as subcarrier set pairs for performing phase measurements.

20. The method of claim 14, further comprising: determining a priority order of a plurality of subcarrier set pairs of the at least one reference signal for performing phase measurements.

21. The method of claim of claim 14, further comprising:
determining a distance to the UE from at least one transmission-reception point (TRP) based on the phase measurement report; and
determining a location of the UE based at least in part on the distance from the UE to the TRP.

22. The method of claim 14, wherein the phase measurement report includes frequency information of the at least one subcarrier set pair.

23. The method of claim 14, wherein the phase measurement report includes information associated with a phase difference between the at least one subcarrier set pair of the at least one reference signal.

24. The method of claim 14, wherein the phase measurement report includes information associated with a wavelength cycle difference between a first number of wavelength cycles of a first subcarrier of the at least one subcarrier set pair and a second number of wavelength cycles of a second subcarrier of the at least one subcarrier set pair.

25. The method of claim 14, wherein the phase measurement report includes information associated with a phase difference between the at least one subcarrier set pair of the at least one reference signal and information associated with a wavelength cycle difference between a first number of wavelength cycles of a first subcarrier of the at least one subcarrier set pair and a second number of wavelength cycles of a second subcarrier of the at least one subcarrier set pair.

26. The method of claim 14, wherein the phase measurement request identifies a measurement type associated the at least one subcarrier set pair, wherein the measurement type comprises at least one of a median, a mean, or a standard deviation.

27. An apparatus for wireless communications, comprising:
a memory; and
one or more processors coupled to the memory, the one or more processors configured to:
receive, from a network entity, a phase measurement request from a network entity, the phase measurement request including properties of one or more pairs of subcarrier sets of at least one reference signal received by the apparatus, wherein a subcarrier set includes at least one subcarrier, and
transmit a phase measurement report to the network entity, the phase measurement report including information associated with a phase measurement performed use at least one subcarrier set pair of the at least one reference signal based on the properties included in the phase measurement request.

28. The apparatus of claim 27, wherein the properties included in the phase measurement request comprise number of subcarrier set pairs of the at least one reference signal to use for performing phase measurements.

29. The apparatus of claim 27, wherein the properties included in the phase measurement request comprise an indication of a specific set of subcarrier set pairs of the at least one reference signal to use for performing phase measurements.

30. The apparatus of claim 29, wherein the properties included in the phase measurement request comprise a respective size of each specific set of subcarrier set pairs of the at least one reference signal.

31. The apparatus of claim 30, wherein the respective size of each specific set of subcarrier set pairs is based on at least one of subcarrier spacing between each specific set of subcarrier set pairs, bandwidth of each specific set of subcarrier set pairs, frequency of each specific set of subcarrier set pairs, or frequency band specific set of subcarrier set pairs.

32. The apparatus of claim 27, wherein the phase measurement request identifies a range of subcarriers that can be used as subcarrier set pairs for performing phase measurements.

33. The apparatus of claim 27, wherein the phase measurement request includes a priority order of a plurality of subcarrier set pairs of the at least one reference signal for performing phase measurements.

34. The apparatus of claim 27, wherein the one or more processors are configured to:
select a set of subcarrier set pairs of the at least one reference signal based on the properties included in the phase measurement request; and
measure a phase difference between each subcarrier in the set of subcarrier set pairs.

35. The apparatus of claim 27, wherein the phase measurement report includes frequency information of the at least one subcarrier set pair.

36. The apparatus of claim 27, wherein the phase measurement report includes information associated with a phase difference between the at least one subcarrier set pair of the at least one reference signal.

37. The apparatus of claim 27, wherein the phase measurement report includes information associated with a wavelength cycle difference between a first number of wavelength cycles of a first subcarrier of the at least one subcarrier set pair and a second number of wavelength cycles of a second subcarrier of the at least one subcarrier set pair.

38. The apparatus of claim 27, wherein the phase measurement report includes information associated with a phase difference between the at least one subcarrier set pair of the at least one reference signal and information associated with a wavelength cycle difference between a first number of wavelength cycles of a first subcarrier of the at least one subcarrier set pair and a second number of wavelength cycles of a second subcarrier of the at least one subcarrier set pair.

39. The apparatus of claim 27, wherein the phase measurement request identifies a measurement type associated the at least one subcarrier set pair and the phase measurement request identifies a measurement type associated the at least one subcarrier set pair.

40. An apparatus for wireless communications, comprising:
a memory; and
one or more processors coupled to the memory, the one or more processors configured to:
transmit, to a user equipment (UE), a phase measurement request including properties of one or more pairs of subcarrier sets of at least one reference signal received by the UE, and
receive, from the UE, a phase measurement report, the phase measurement report including information associated with a phase measurement performed use at least one subcarrier set pair of the at least one reference signal based on the properties included in the phase measurement request.

41. The apparatus of claim 40, wherein the properties included in the phase measurement request comprise number of subcarrier set pairs of the at least one reference signal to use for performing phase measurements.

42. The apparatus of claim 40, wherein the properties included in the phase measurement request comprise an indication of a specific set of subcarrier set pairs of the at least one reference signal to use for performing phase measurements.

43. The apparatus of claim 40, wherein the properties included in the phase measurement request comprise a respective size of each specific set of subcarrier set pairs of the at least one reference signal.

44. The apparatus of claim 43, wherein the respective size of each specific set of subcarrier set pairs is based on at least one of subcarrier spacing between each specific set of subcarrier set pairs, bandwidth of each specific set of subcarrier set pairs, frequency of each specific set of subcarrier set pairs, or frequency band specific set of subcarrier set pairs.

45. The apparatus of claim 40, wherein the phase measurement request identifies a range of subcarriers that can be used as subcarrier set pairs for performing phase measurements.

46. The apparatus of claim 40, wherein the one or more processors are configured to:
determine a priority order of a plurality of subcarrier set pairs of the at least one reference signal for perform phase measurements.

47. The apparatus of claim 40, wherein the one or more processors are configured to:
determine a distance to the UE from at least one transmission-reception point (TRP) based on the phase measurement report; and
determine a location of the UE based at least in part on the distance from the UE to the TRP.

48. The apparatus of claim 40, wherein the phase measurement report includes frequency information of the at least one subcarrier set pair.

49. The apparatus of claim 40, wherein the phase measurement report includes information associated with a phase difference between the at least one subcarrier set pair of the at least one reference signal.

50. The apparatus of claim 40, wherein the phase measurement report includes information associated with a wavelength cycle difference between a first number of wavelength cycles of a first subcarrier of the at least one subcarrier set pair and a second number of wavelength cycles of a second subcarrier of the at least one subcarrier set pair.

51. The apparatus of claim 40, wherein the phase measurement report includes information associated with a phase difference between the at least one subcarrier set pair of the at least one reference signal and information associated with a wavelength cycle difference between a first number of wavelength cycles of a first subcarrier of the at least one subcarrier set pair and a second number of wavelength cycles of a second subcarrier of the at least one subcarrier set pair.

52. The apparatus of claim 40, wherein the phase measurement request identifies a measurement type associated the at least one subcarrier set pair and the phase measurement request identifies a measurement type associated the at least one subcarrier set pair.
